(19) United States
(12) Patent Application Publication
(10) Pub. No.: US 2024/0370765 A1
(43) Pub. Date: Nov. 7, 2024

(54) System and Method for Building Custom Models

(71) Applicant: Telepathy Labs, Inc., Tampa, FL (US)

(72) Inventors: Piero Pierucci, Zurich (CH); Steven Mudda, Zurich (CH); Pierre-Edouard Honnet, Zurich (CH); Roman Schroeder, Zurich (CH)

(73) Assignee: Telepathy Labs, Inc., Tampa, FL (US)

(21) Appl. No.: 18/256,466

(22) PCT Filed: Dec. 17, 2021
(86) PCT No.: PCT/US2021/064164

§ 371 Date: Jun. 8, 2023

Related U.S. Application Data
(60) Provisional application No. 63/126,797, filed on Dec. 17, 2020.

(51) Int. Cl. G06N 20/00

(52) U.S. Cl. CPC G06N 20/00

(57) ABSTRACT

A method, computer program product, and computer system for building a custom model, performed by one or more computing devices, may include but is not limited to registering at least one module. A request may be received from a user application. A request queue may be filled with request information related to the request. The at least one module may be triggered based on the request information. At least part of the request may be processed based on data assets related to the request. A custom model may be built based on, at least in part, the processing of the at least part of the request.

### RELATED APPLICATION PARAGRAPH

This application is a U.S. National Stage of International Application No. PCT/US2021/064164, filed 17 Dec. 2021, which claims the benefit of U.S. Provisional Application No. 63/126,797, filed on 17 Dec. 2020, the contents of which are incorporated herein by reference.

### BACKGROUND

There are some known software applications that use machine learning-based algorithms. Some of these software applications use predefined machine learning (ML) models based on a certain amount of data. For example, some companies that provide ML training services offer an application programming interface (API) to upload a specific dataset in order to adjust (e.g., “fine tune”) a pre-existing and pre-trained ML model.

### BRIEF SUMMARY OF DISCLOSURE

According to some example embodiments of the disclosure, a method is disclosed. The method may be a computer-implemented method for building a custom model. The method may include but is not limited to registering at least one module. A request may be received from a user application. A request queue may be filled with request information related to the request. The at least one module may be triggered based on the request information. At least part of the request may be processed based on data assets related to the request. A custom model may be built based on, at least in part, the processing of the at least part of the request.

According to example embodiments, one or more of the following example features may be included. The request information may include at least one of: a request workflow, a list of one or more required modules, or a topic. At least one second module may be registered and the at least one second module may be triggered based on the request information. The at least one module is at least one processing manager and the at least one second module is at least one request handing agent.

According to some example embodiments of the disclosure, a method is disclosed. The method may be a computer-implemented method for building a custom model. The method may include but is not limited to registering, by a request queue, a custom machine learning model (MLM) server, at least one processing manager, and at least one request handling agent. A request from a user application may be received by the custom MLM server. The request queue with request information related to the request may be filled by the custom MLM server. The request information may include at least one of a request workflow, one or more required processing managers, or a topic. The at least one request handling agent may be triggered based on the request information in the request queue. The at least one processing manager may be triggered based on the request information as directed by the at least one request handling agent. At least part of the request may be processed based on data assets related to the request using the at least one processing manager. A custom model may be built based on, at least in part, the processing of the at least part of the request.

According to example embodiments, one or more of the following example features may be included. In example embodiments, the custom MLM server filling the request queue with the request information may include building, by the custom MLM server, the request workflow, and adding the request workflow to the request thereby modifying the request to an augmented request that is pushed into the request queue. The at least one request handling agent may analyze the augmented request for the request workflow. The request handling agent may distribute information about required processing managers in the request queue having associated one or more topics. When the topic is marked in the request queue, the associated processing manager may be triggered. The at least one request handling agent may send a message in the form of a further augmented request that may be associated with the topic to the request queue. The request queue may send the further augmented request to the at least one processing manager associated with the topic triggering the at least one processing manager. The topic of the augmented request may be added or changed depending on a stage in the request workflow. The at least one request handling agent may determine that the augmented request relates to at least one processing manager or a group of processing managers based on the added or changed topic being associated with the at least one processing manager or the group of processing managers. In example embodiments, the custom MLM server filling the request queue with request information may include creating, by the custom MLM server, the request workflow for the request. The request workflow may include descriptions of one or more processing steps required for fulfilling the request. When one of the one or more processing steps is completed, the at least one request handling agent may activate another next processing manager by marking a next topic in the augmented request of the request queue that may be associated with the next processing manager. In example embodiments, the custom MLM server filling the request queue with request information may include the custom MLM server creating the request workflow for the request. The custom MLM server may create the request workflow by determining which processing managers are required for fulfilling the request and may add these required processing managers to the request workflow. In example embodiments, the custom model may be a language model such that the one or more processing steps of the workflow may include a language modeling step, a grapheme-to-phoneme (G2P) step, and a decoding model building step. The at least one processing manager may include three different processing managers such as a first processing manager, a second processing manager, and a third processing manager. The first processing manager may execute the language modeling step, the second processing manager may execute the grapheme-to-phoneme (G2P) step, and the third processing manager may execute the decoding model building step. The language modeling step may include normalizing of user data, the grapheme-to-phoneme (G2P) step may include phonetizing data, and the decoding model building step may include building of a decoding graph. In example embodiments, the custom model may be at least one of: a language model for automatic speech recognition (ASR), a natural language understanding (NLU) machine learning (ML) model, a natural language generation (NLG) ML model, a dialog management (DM) ML model, or a text-to-speech (TTS) ML model. In example embodiments, the at least one processing manager may be registered to monitor for the topic such that whenever a message is queued in the augmented request for the topic, the at least one processing manager associated with the topic may receive the pushed message triggering the at least one processing manager. In example embodiments, the built custom model may be a decoding graph binary file. In example embodiments, the custom MLM server, the at least one request handling agent, and the at least one processing manager may be registered as at least one of publishers or subscribers. During registration, the custom MLM server may create one or more folders in the data assets to serve the request. In example embodiments, the custom MLM server filling the request queue with request information may include modifying the request to associate any new request information with the request which converts the request to an augmented request. The topic may be an initial topic triggering the at least one request handling agent. Other topics may relate to different stages of the request workflow. The initial topic of the augmented request may be changed to at least one of the other topics causing at least one of an action or triggering of the at least one processing manager. In example embodiments, the request may include text, an intended result, and ancillary data that may be modified based on new information converting the request to an augmented request. In example embodiments, the method may include interpreting, by the at least one request handling agent, the request work for determining whether all required processing managers have completed their processing in relation to building the custom model. If the at least one request handling agent determines that all required processing managers have completed their processing, then the custom MLM server may be signaled of the fulfillment of the request. After the custom model is built, a reload of the requested custom model in a runtime system may be triggered.

According to some example embodiments of the disclosure, a system is disclosed. The system may be a computing system for building a custom model including one or more processors and one or more memories configured to perform operations. The operations may include but are not limited to registering, by a request queue, a custom machine learning model (MLM) server, at least one processing manager, and at least one request handling agent. A request from a user application may be received by the custom MLM server. The request queue with request information related to the request may be filled by the custom MLM server. The request information may include at least one of a request workflow, one or more required processing managers, or a topic. The at least one request handling agent may be triggered based on the request information in the request queue. The at least one processing manager may be triggered based on the request information as directed by the at least one request handling agent. At least part of the request may be processed based on data assets related to the request using the at least one processing manager. A custom model may be built based on, at least in part, the processing of the at least part of the request.

According to example embodiments, one or more of the following example features may be included. In example embodiments, the request queue may be a facility for transporting information or data including requests from the custom MLM server to one or more processing managers. The request workflow may include a resulting workflow graph corresponding to the request including one or more processing steps required for fulfilling the request Each workflow graph may be created by the custom MLM server, and each workflow graph may be managed by the at least one processing manager. The at least one processing manager may be sequenced through the at least one request handling agent. In example embodiments, the at least one processing manager may be associated with one or more docker images including at least one of resources or static files, input data, or output data. In example embodiments, the data assets may include at least one network file system server that may store at least one of: server resources, server input data, or server output data. The at least one processing manager may include a network file system client that receives information from the at least one network file system server via data asset links. The network file system client may include at least one of: client resources configured to receive information from the server resources, client input data configured to receive information from the server input data, or client output data configured to receive information from server output data. In example embodiments, the operations may further include starting the at least one network file system server and the at least one processing manager. Folders from the at least one network file system server may be automatically mounted. A process associated with the at least one processing manager may be started based on the server input data from the at least one network file system server. Processed output may be written to the client output data of the network file system client. In example embodiments, the process may be at least one of: a language modelling process for creating, interpolating, and pruning language models; a grapheme-to-phoneme (G2P) process for providing G2P conversion; or a decoding model building process for constructing, combining, optimizing, and searching weighted finite-state transducers (FSTs). In example embodiments, the request queue may include data having default configuration data, service location data, and key/value data. The at least one processing manager may include a configuration management function configured to manage local application configuration using templates and the data from the request queue. Each processing manager may include a different configuration management function, and each configuration management function may be used with a configuration management system for actively monitoring the key/value data for any key/value changes impacting configuration data. The at least one processing manager may use the configuration management function to sync configuration data by polling the request queue and processing template resources. The at least one processing manager may use the configuration management function with keys of the key/value data. At least one key of the keys may activate the at least one processing manager. In example embodiments, the custom MLM server may include an identity server configured to create, maintain, and manage identity information for principals while providing authentication services to relying applications within a network.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a custom machine learning model building process coupled to an example distributed computing network according to one or more example implementations of the disclosure;

FIG. 2 is an example diagrammatic view of a client electronic device of FIG. 1 according to one or more example implementations of the disclosure;

FIG. 3 is an example flowchart of a custom machine learning model building process according to one or more example implementations of the disclosure;

FIG. 4 is an example block diagram of a system for building a custom machine learning model, in accordance with one or more example implementations of the disclosure;

FIGS. 5A-5N are example block diagrams of the system of FIG. 4 at each stage of a custom machine learning model building process, in accordance with one or more example implementations of the disclosure;

FIGS. 6A-6C are other example block diagrams of different processing managers interacting with data assets as part of another system, in accordance with one or more example implementations of the disclosure;

FIG. 7 is a detailed block diagram of the system of FIGS. 6A-6C, in accordance with one or more example implementations of the disclosure;

FIGS. 8A-8C are example block diagrams of the system of FIGS. 6A-7 at three different stages of a custom machine learning model building process, in accordance with one or more example implementations of the disclosure;

FIG. 9 is another detailed example block diagram of the system of FIGS. 6A-8C for building a custom machine learning model, in accordance with one or more example implementations of the disclosure; and

FIG. 10 is an example block diagram of another system for building a custom machine learning model, in accordance with one or more example implementations of the disclosure;

Like reference symbols in the various drawings indicate like elements.

### DETAILED DESCRIPTION

Some current systems offered by the machine learning (ML) services may have limitations. For example, some ML service systems may have limited control on model choice (e.g., ML service system may only pick one among several models that are offered) and are typically only offered on their parameters. Accordingly, if the model to be addressed is not covered by one of these pre-existing models then these ML service systems may not be used.

There are complexity problems with building models and training models that may be addressed by the disclosure. For example, the process of building an ML model is often a complex task involving several processing steps, with the sequence of the steps being variable, and with each step being implemented with different programs and different computing requirements. Specifically, some of the related complexities may include the extreme diversity of the processing chain that may be needed to train one specific ML algorithm versus another ML algorithm, the large number of different frameworks and computing devices that may be required to support ML training, the complexity associated with handling a relatively large quantity of data sets, and the frequent need for fine tuning hyperparameters. These complexities can make the task of ingesting and processing new data to build or update a runtime ML model difficult to complete.

As such, in some implementations, the example top technical complexities and problems resulting from use of ML algorithms may include variability of the processing steps, diversity of the computing requirements, and the distributed nature (e.g., across the net) of the computing system. Variability of steps, for example, may generally refer to examples where different ML algorithms may be adopted to treat a specific ML model problem. Some algorithms may refer, for instance, to a TensorFlow® framework, some to Keras™ framework, some to GNU Octave™/Matlab® framework, etc. To update the specific ML model, a different type of computing node may need to be setup depending on the adopted framework.

In example implementations, the disclosure may address these complexity problems. These complexity problems may be addressed by a custom model building process and/or other processes in the disclosure. Specifically, the disclosure may include a process for ingesting enterprise data (e.g., company data, organizational data, etc.) and updating runtime ML models while addressing related complexities and difficulties in performing this process. The disclosure may address these complexities/problems and manage complex workflows when training ML algorithms and building custom models.

For instance, the disclosure may address a distributed computing system associated with a specific ML model computation. There may be a convenience in offering an encapsulated ML training system that may design the distribution of the computing system in a way that may be related to the specific ML model computation. For example, for the specific ML model computation, the custom model building process and/or other processes in the disclosure may include several steps that may be run in parallel and in different machines as well as steps that may need to recombine outputs of previous steps into one single processing element before producing results that may be used for later steps. This is an example where the distributed nature of processing steps may be managed autonomously by the custom model building process and/or other processes with a purpose of optimizing the ML model computation.

While there are some solutions for certain sequences of processing steps relating to predefined infrastructures, these solutions may have their limitations. For example, some of these solutions may offer training of an ML model that may be used for processing a defined amount of data, producing a partially defined ML model, and combining results in different files. However, with these solutions, data ingestion may still be a problem that may be addressed by building an entire set of ML capable processes to clean up the data, extract meaningful portions, calculate partial representations, and then store results. For these solutions, a dataset may be prepared, and processing may be performed in a specific framework calling for diverse computing requirements. That is, these solutions may not be aimed at representing and implementing a full process from data ingestion to a final ML model production as addressed by the disclosure.

In some implementations, the disclosure may include a sub-subsystem. Specifically, the sub-subsystem may ingest new customer data and produce a customized ML model ready to use by the runtime system. This may be useful, for example, for circumstances where users may prefer full control of their own data and want to have the custom model process installed “on-premise” (e.g., on a private cloud under control of the user).

The disclosure may address the above-described complexity issues and problems by, for example, introducing several components aimed at receiving requests (e.g., user requests), preparing a structure of the processing steps for implementing the requests, and directing these requests into a distributed “request queue”. For example, variability of processing steps may be addressed by a specific capability (e.g., pipeline planner) in which a specific request may be received, and the request may be added to a queue of process requests. Descriptions of the separate steps that may be needed for the ML model computation (e.g., ML pipeline) may be linked to the requests. These descriptions may be calculated once and remain stable until the end of the processing of requests. Once the pipeline planner has been designed and linked to the requests, the pipeline planner may be executed by one or more different computing nodes dispersed across a network (e.g., each computing node may have different computing requirements). At each individual processing step conclusion, the produced partial results may be used to trigger a next step in the chain.

Some of the known solutions relating to predefined infrastructures may have limitations. For example, some solutions may be difficult to use in a general manner for different ML-based specific examples. For instance, a user may not be able to run an ML computation pipeline based on, e.g., Microsoft (MS) Azure™ service which may not be applicable because of security reasons and is therefore not customizable. Also, solutions relating to predefined infrastructures may require some adoption of a specified framework tied to a given cloud provider (e.g., Amazon Web Services™) and/or specific ML provider (e.g., Azure™). For example, solutions based on an MS Azure™ ML provider may only run on MS Azure™ cloud. However, these services may not be used in situations involving proprietary data because the MS Azure™ cloud service may imply sharing of data ownership with the MS Azure™ ML provider. Also, these predefined infrastructure solutions may not be viable options for users interested in on-premise solutions. In contradistinction, in some example embodiments, the disclosure may provide a different approach, e.g., without implying data sharing, without the restrictions related to data ownership, and may run on any type of cloud platform.

There are several differences between the disclosure compared to similar technologies providing non-limiting advantages. For example, many model building technologies that exist may force users to push data off premise. In contrast, the disclosure provides systems and/or processes that may be run on premise for users. Some other examples of non-limiting advantages of the disclosure may include, e.g., being fully scalable, being distributed and redistributable, etc. Further, in contrast from some known technologies, the disclosure may offer solutions that may be flexible and not static as processes. In contrast from some known technologies, the disclosure may offer a generalized process and/or system that may be flexibly used in all use cases. The systems and/or processes of the disclosure may serve all possible users (e.g., variety of user organizations) with an undefined structure which may be changed in real-time. The systems and/or processes of the disclosure may be used to build new graphs that may not have been present before which may make these systems and/or processes highly extensible.

The disclosure may offer other non-limiting advantages. For example, the disclosure includes systems and/or processes that may be scaled indefinitely, according to computing requirements, as being fully distributed. This allows these systems and/or processes to be implemented across various regions and geographic areas. The systems and/or processes of the disclosure may be fully configurable in that the systems and/or processes may be completely independent from any single ML algorithm model being constructed. The disclosure may offer example systems that are robust in that they are extremely flexible for building remedies for failures and out-of-service conditions.

In some implementations, there may be a desire for customized models to be built on premise versus off premise fulfilling some users' preferences. In some example systems and/or processes, there may be customized models that may be created by one organization (e.g., models may be calculated off-premise) and then shipped for use by another second organization (e.g., user organization that may use the shipped customized model). However, several user organizations may be interested in building customized models on-premise by using the systems and/or processes (e.g., a facility system) where they can use data without the need to send data off-premise. When the on-premise facility receives the data, it may trigger a complex sequence of actions for building a new model for a machine algorithm which may be used in a run-time system. This on-premise facility system may be used by users directly to customize machine learning models. The output of this facility system may be a customized model (e.g., binary file of customized model) which may be deployed on-premise for the user organization. This may benefit organizations that prefer being able to drive their own updates as well as maintain secure control over handling of their own data by using the systems and/or processes of the disclosure.

### System Overview

In some example implementations, the disclosure may offer an example system that may include “request handling” agent(s) (e.g., may also be referred to as module(s)) and a “request queue”. A scalable number of “request handling” agent(s) may be registered to be triggered by the addition of an element (e.g., addition off a request such as a generic process request specifically the topic of the request may trigger the request handling agent(s)) in the “request queue” and act upon this request by pushing an augmented request (e.g., modified request as described in the disclosure) into the “request queue” for processing. For example, the request handling agent(s) may utilize the request information of the augmented request to sequence through different processing managers PMs (e.g., trigger at least one processing manager for fulfilling a request). The request queue may contain one or more augmented requests in the form of a complex object where each augmented request includes a request workflow that describes the steps that may be needed to implement the request (e.g., workflow of steps needed to build the requested customized language model may be added by the custom MLM server 112 when converting the original requests to augmented requests).

The example system may include at least one “processing manager” (PM) (e.g., may also be referred to as module, processing agent, or processing module). For instance, building a new language model for automatic speech recognition (ASR) may imply a sequence of actions described as a “pipeline” of one, two, or three processing managers (PMs) to be executed one after the other. In this sense, one “element” in the “request queue” may correspond to one request (e.g., user request for customized language model). The augmented request may include a workflow that may be defined as a representation of a sequence of steps that may be needed to accomplish the custom model building (e.g., steps may include a language modeling step, a grapheme-to-phoneme (G2P) step, and a decoding model building step). The request may be a “generic process” request such that the request queue may include several requests where the “generic request” may refer to “n-th” or “the request number n”. The request queue may represent that for each processing manager (PM), there may be a separate addressable item (e.g., topic T #) in each augmented request. As an analogy, this is similar to a post office where surface mail objects may be received in one big container and then separated in different queues based on different cities. Similarly, each PM may be associated with a separate distinct topic T relating to a location and/or use of PM. Each distinct topic T may refer to a distinct “argument” to which the associated processing manager PM may be registered as a triggered event (e.g., first topic T1 may refer to associated first processing manager PM1). Processing managers (PMs) may support some of the training work that may be needed to create a requested custom machine learning (ML) model (e.g., custom ML language model). The example system may include at least one processing manager PM such that the number of PMs (e.g., one to six PMs) may correspond with the number of possible distinct steps for creating optional ML models.

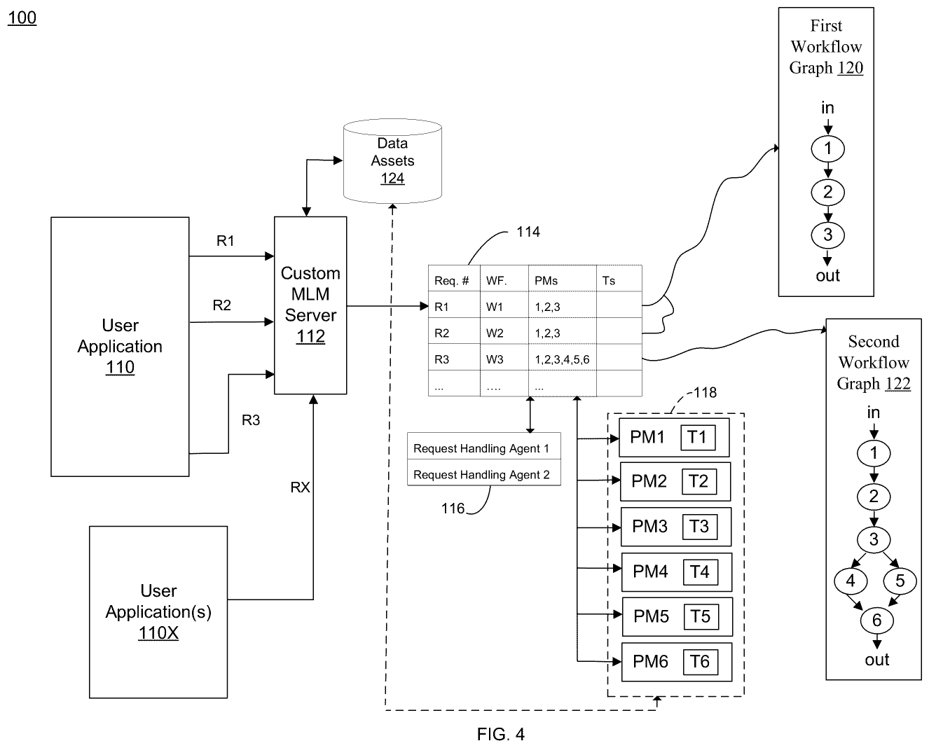

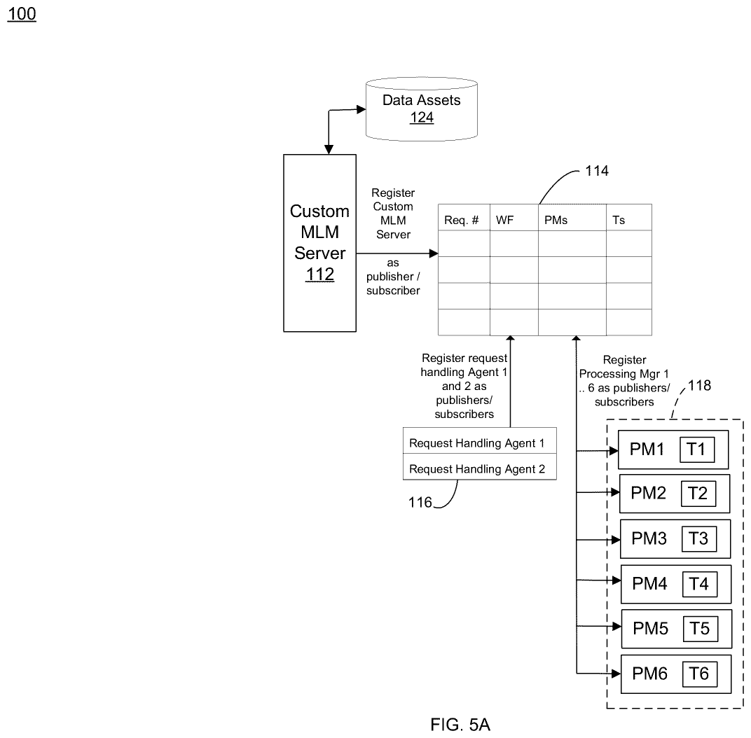

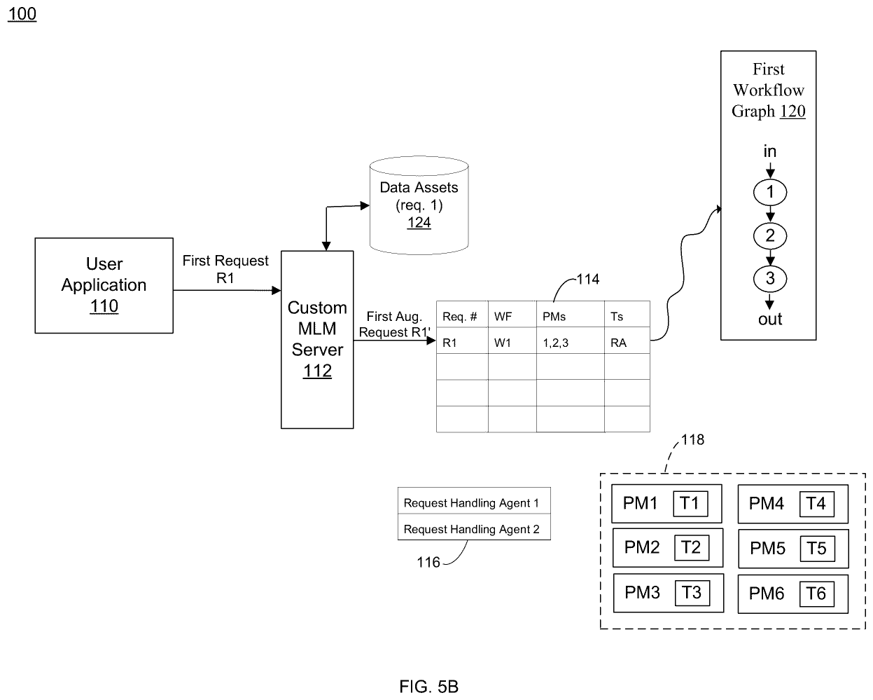

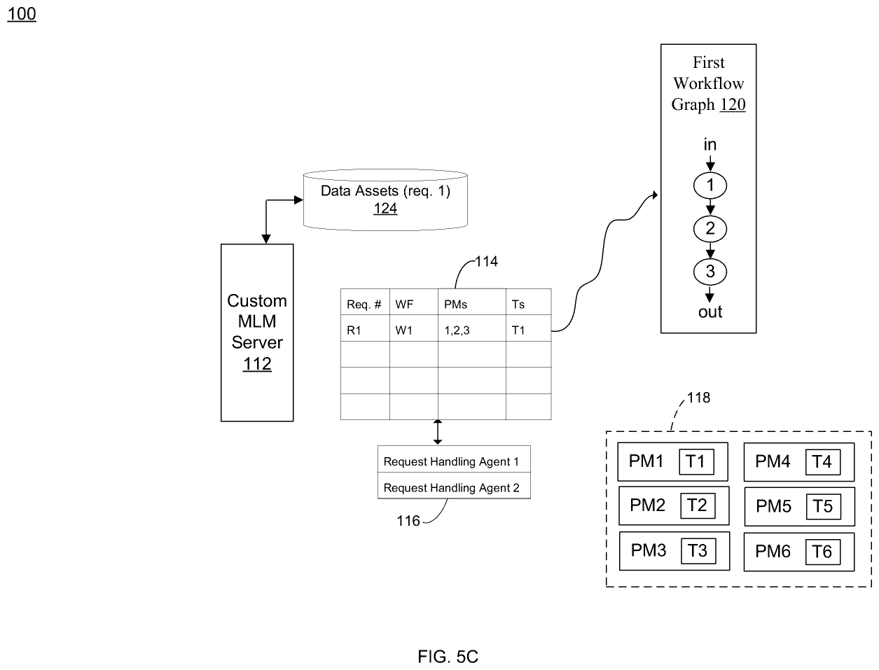

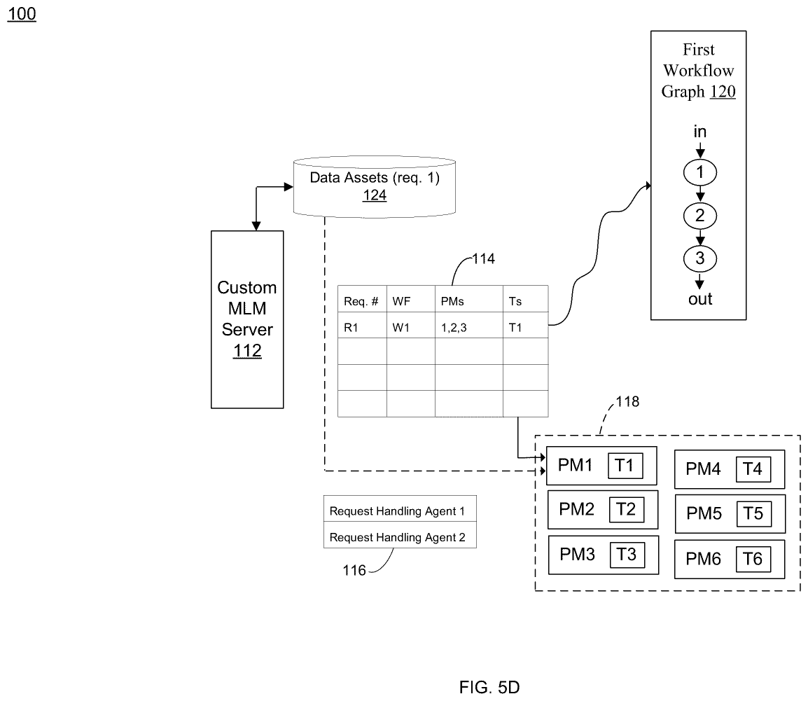

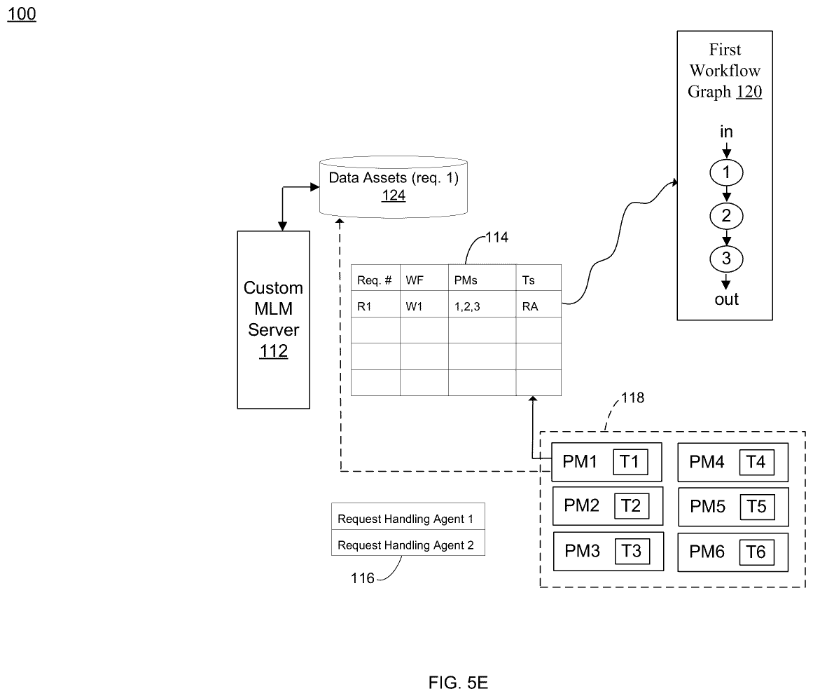

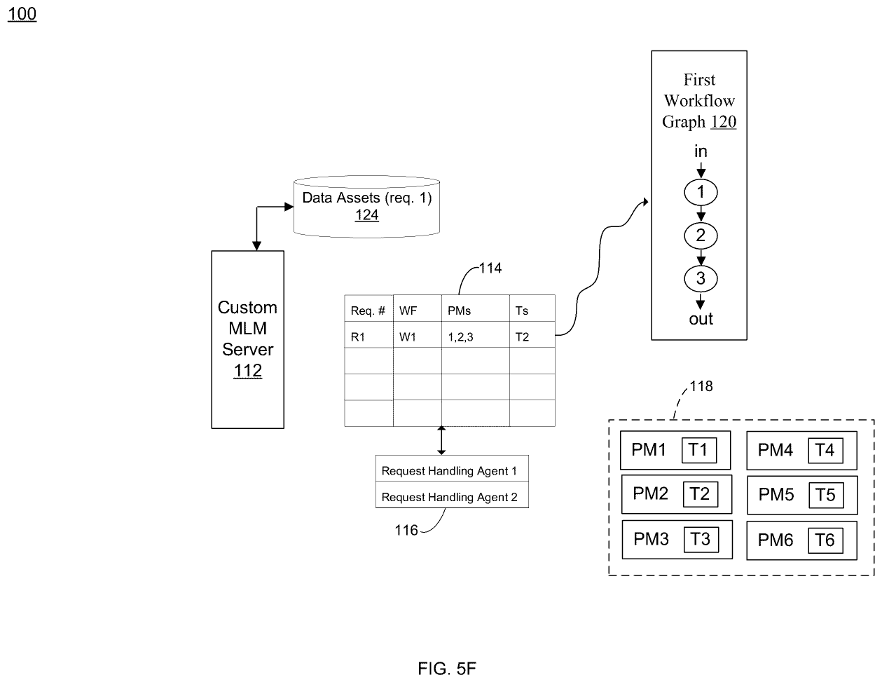

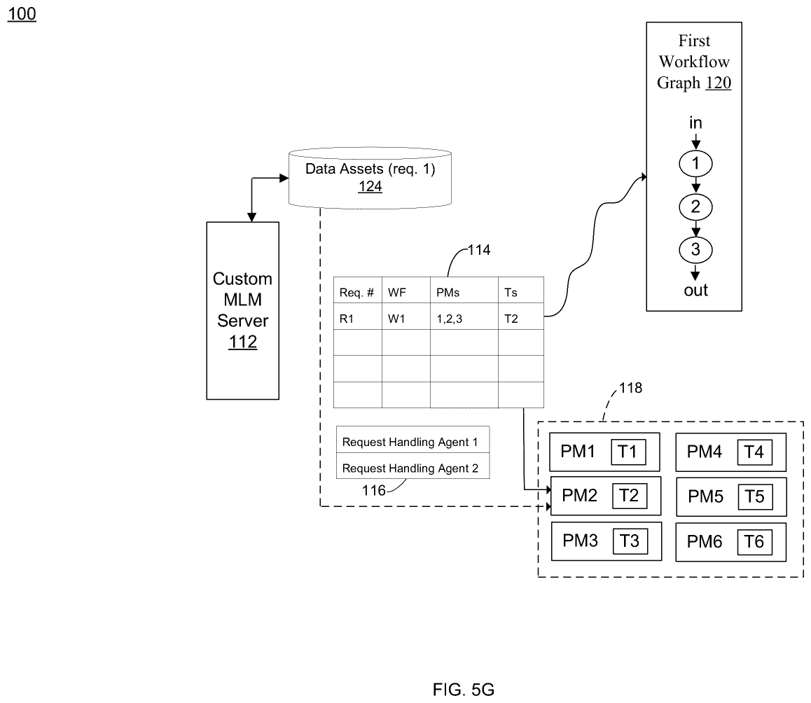

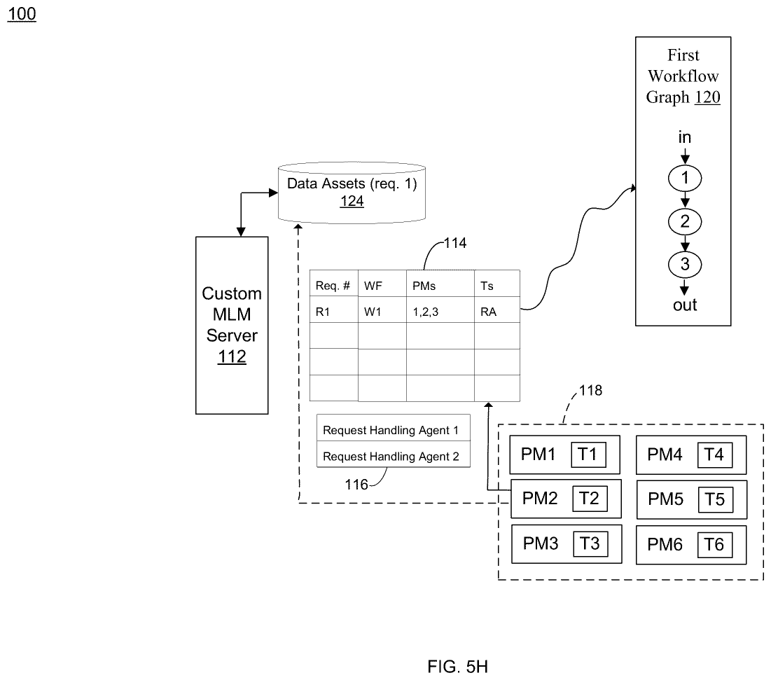

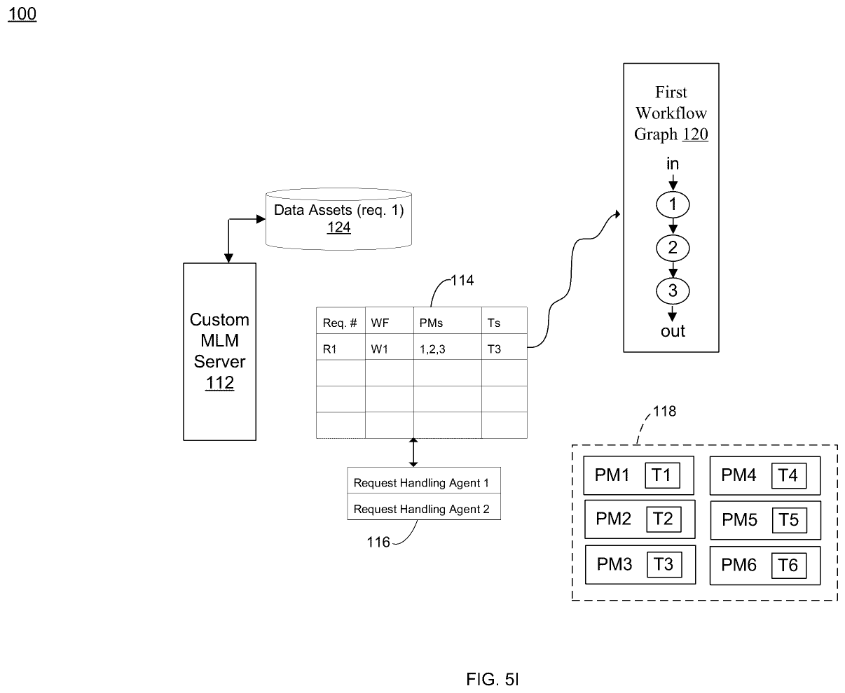

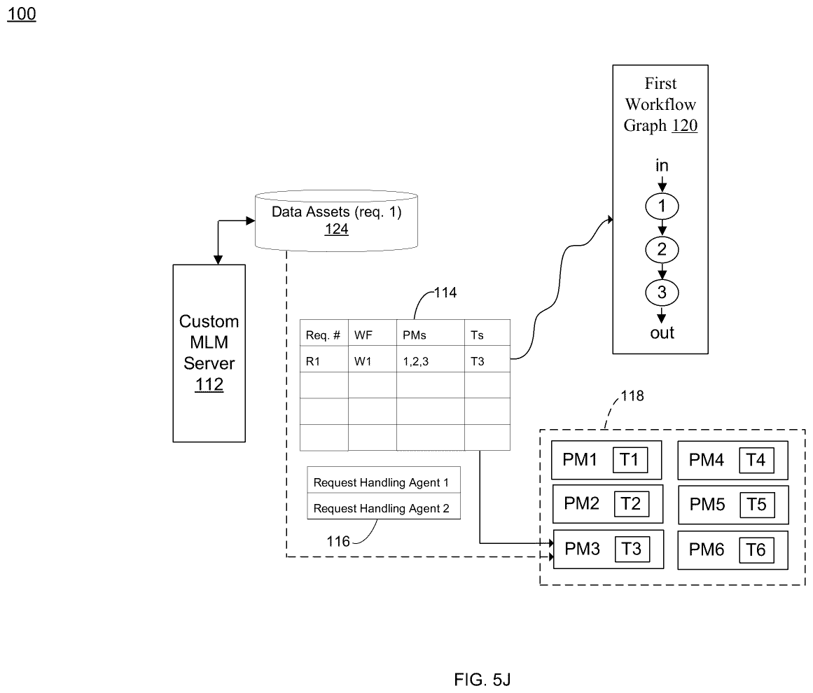

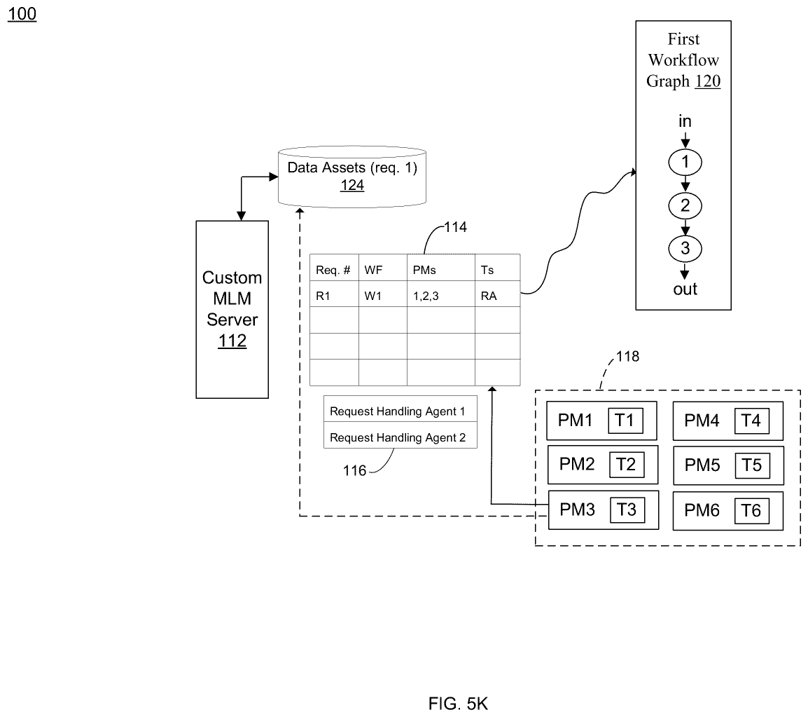

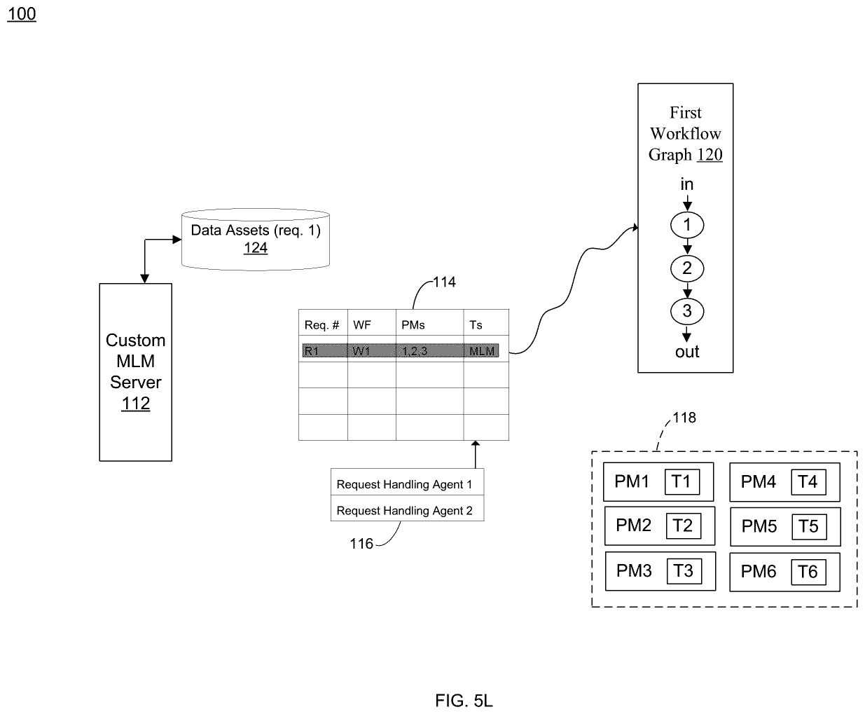

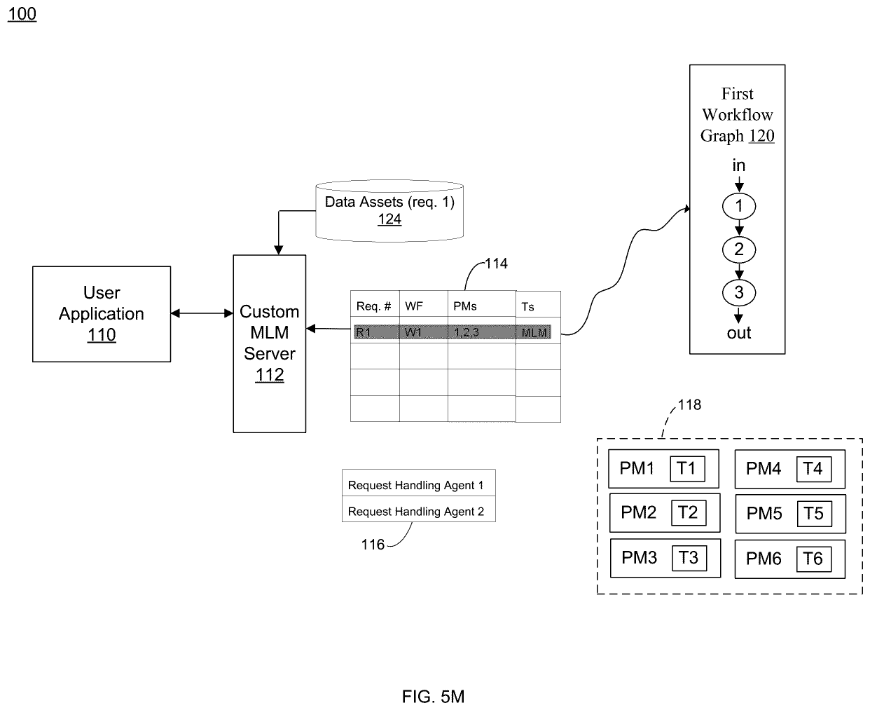

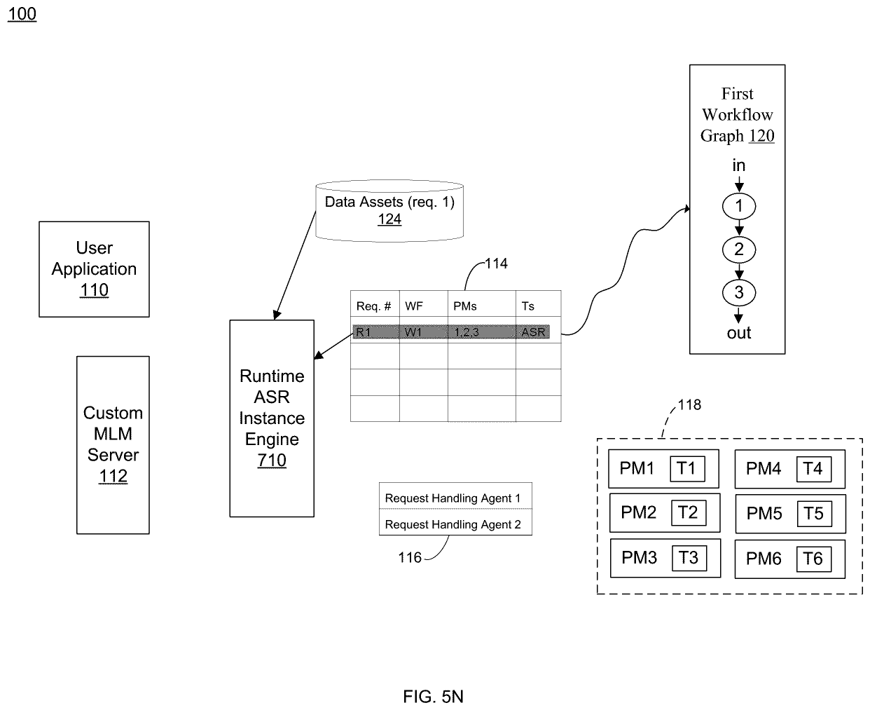

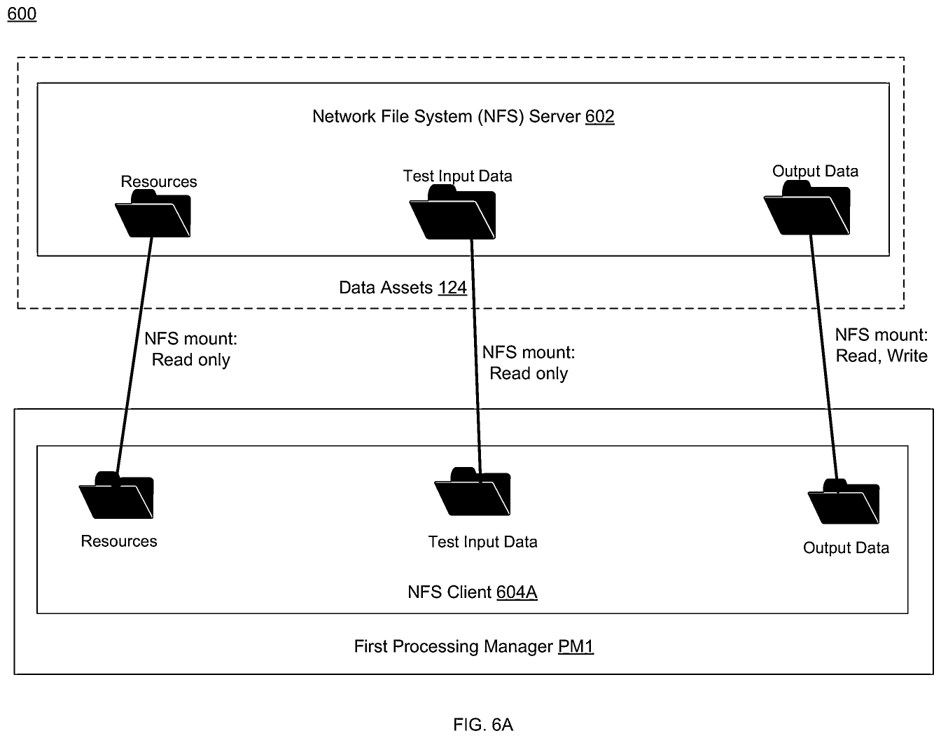

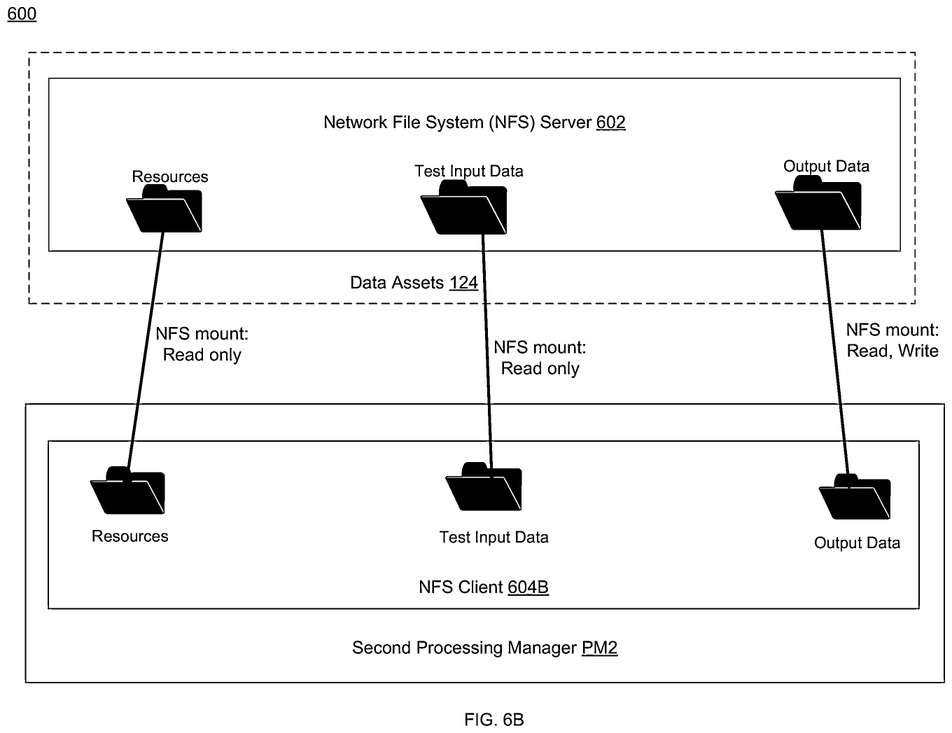

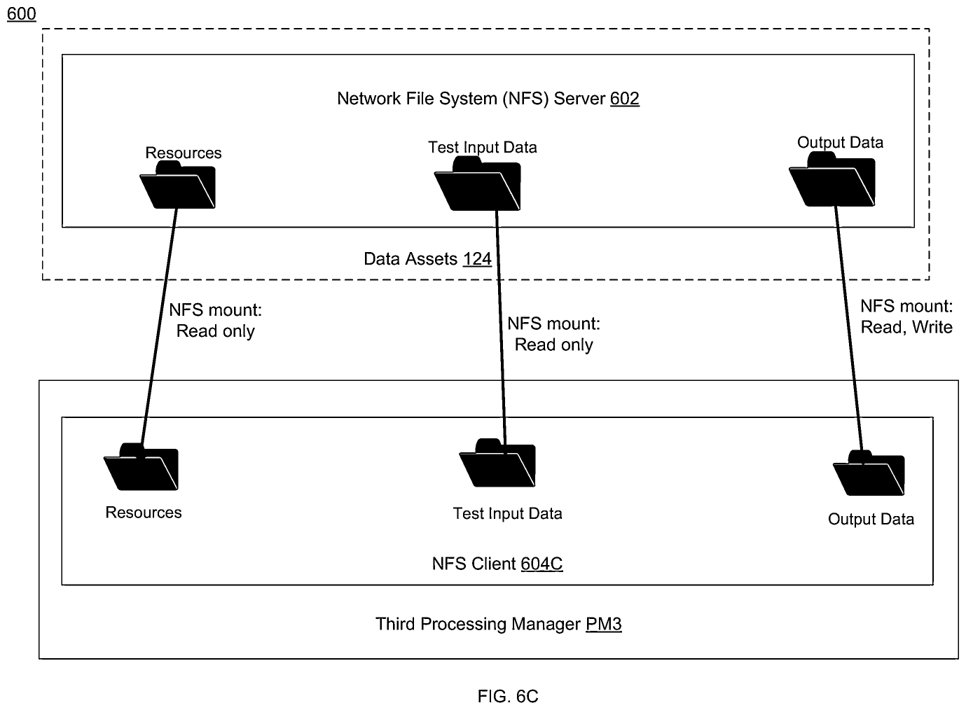

Request handling agent(s) may have the task of sequencing a job through different processing managers PMs. In some examples, there may be zero (0) request handling agents (as shown in FIGS. 6A-10) in which the request handling agent may not be explicitly present but instead the functionality or actions of the request handling agent may be embedded partially in one or more of the other components (e.g., embedded in processing managers PM1, PM2, PM3 of FIGS. 6A-10). For these examples, the functionality of the request handling agents may be implicit in the processing managers operations. In other examples, one or more request handling agents or managers (e.g., request handling agents or managers in FIGS. 4-5N) may be included. The number of request handling managers may correspond to an increased scalability of the custom ML model solution. Having more than one request handling manager may increase the distributed, robust, and resilient nature of the entire solution. In the broader scheme, as shown in FIGS. 4-5N, the system may include three request handling managers and six processing managers with the number of request handling managers being uncorrelated with number of processing managers. Where two or more directions may be included in a workflow (e.g., second workflow graph 122 of FIG. 4) that include at least two steps (e.g., steps 4 and 5 of second workflow graph 122) branching out as two directions (e.g., branching from step 3), at least one request handling agent may be required, otherwise a request handling agent may not be required.

One example of the system may include at least one “request handling” agent and at least one processing manager. A scalable number of “request handling” agents may be registered to be triggered by the addition or change of the topic T in the augmented request (e.g., topic T of augmented request may be added or changed to “RA”). The triggered request handling agents may further change the topic T of the augmented request to be directed to a specific processing manager by referring to a topic that may be associated with the specific processing manager (e.g., first topic T1 may be associated with the first processing manager PM1, second topic T2 may be associated with the second processing manager PM2, etc.). Each processing manager may include functionality for processing at least one step (e.g., related to topic T1, T2, T3 such as functionality for a language modeling step, a G2P step, or a decoding model building step) for fulfilling the request. The request handling agent(s) may act upon the executed processing manager and push results (from the executed processing manager) into a “processing results” queue monitored by the “request handling” agent(s). The processing may continue until the last processing step of a workflow graph may be completed.

As such, in some example implementations, the disclosure may include three agents (e.g., from three different agent classes) for handling requests along with different queues for allowing these agents to communicate across a distributed architecture. These three different agent classes may include, e.g.: “Request Handling Agent(s)”, “Request Queue(s)”, and “Processing Manager(s)”. In summary, the request handling agents may assist with processing requests (e.g., organization requests) by directing triggering of one or more processing managers (e.g., via one or more request queues). The number of instances of these request handling agents may be scaled indefinitely. The output (e.g., change of topic T) of the request handling agents may be queued into a “request queue” (may also be referred to as “request queue agent”). The request queue may handle queues for request information (e.g., request details) for one or more requests and may be part of a second class of agents. The number of instances of the request queue may be one or also may be scaled indefinitely. The augmented request of the request queue may trigger several different “processing manager(s)” (e.g., one specific topic for each different type of processing manager such that a first topic T1 may correspond with a first processing manager PM1). The “processing manager(s)” may be part of a third separate class of agents that may handle “processing” of different steps of workflow for a request (e.g., specific processing manager for each step). The number of instances of processing manager(s) may be scaled indefinitely. The output of these processing manager(s) may be queued into different “processing results” of the augmented request in the request queue and may be monitored by related request handling agents.

The disclosure may offer other example and non-limiting advantages. For example, some advantages may include complete configurability, distributed processing, and robustness. The disclosure may allow an organization to tailor an implementation of the computing sequence in a way to maximally accelerate calculation of complex ML models ideally in a timeframe that may allow for fast and frequent updates of customized services based on ML.

In some example implementations, the disclosure may be embodied as a method, system, or computer program product. Accordingly, in some example implementations, the method, system, or computer program product of the disclosure may take the form of an entirely hardware implementation, an entirely software implementation (including firmware, resident software, micro-code, etc.), or an implementation combining software and hardware aspects that may all generally be referred to herein as a “circuit,” “module” or “system.” Furthermore, in some example implementations, the disclosure may include a computer program product on a computer-usable storage medium having computer-usable program code embodied in the medium.

In some example implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the disclosure, a computer-usable or computer-readable, storage medium may be any tangible medium that can contain or store a program for use by or in connection with the instruction execution system, apparatus, or device.

In some example implementations, a computer readable signal medium may include a propagated data signal with computer readable program code embodied therein, for example, in baseband or as part of a carrier wave. In some example implementations, such a propagated signal may take any of a variety of forms, including, but not limited to, electro-magnetic, optical, or any suitable combination thereof. In some example implementations, the computer readable program code may be transmitted using any appropriate medium, including but not limited to the internet, wireline, optical fiber cable, RF, etc. In some example implementations, a computer readable signal medium may be any computer readable medium that is not a computer readable storage medium and that can communicate, propagate, or transport a program for use by or in connection with an instruction execution system, apparatus, or device.

In some example implementations, computer program code for carrying out operations of the disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some example implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the disclosure.

In some example implementations, the flowchart and block diagrams in the figures show the architecture, functionality, and operation of possible implementations of apparatus (systems), methods and computer program products according to various implementations of the disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some example implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some example implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some example implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

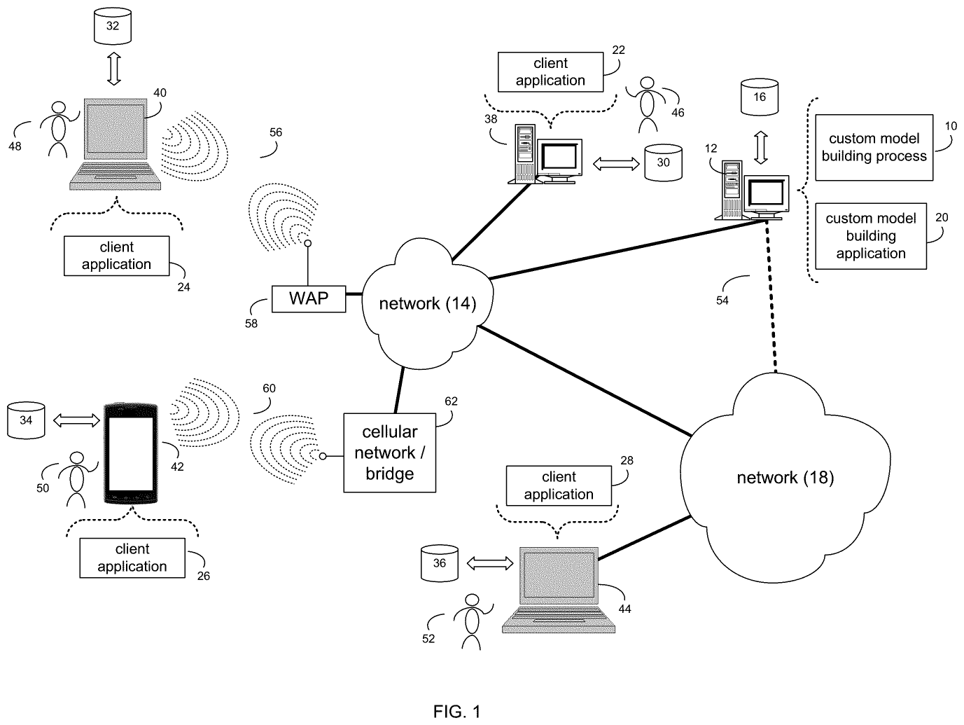

Referring now to the example implementation of FIG. 1, there is shown custom model building process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). In some example implementations, each of the aforementioned may be generally described as a computing device. In certain implementations, a computing device may be a physical or virtual device. In many example implementations, a computing device may be any device capable of performing operations, such as a dedicated processor, a portion of a processor, a virtual processor, a portion of a virtual processor, portion of a virtual device, or a virtual device. In some example implementations, a processor may be a physical processor or a virtual processor. In some example implementations, a virtual processor may correspond to one or more parts of one or more physical processors. In some example implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some example implementations, as will be discussed below in greater detail, a custom model building process, such as a custom model building process 10 of FIG. 1, may register at least one module (e.g., at least one processing manager). The custom model building process 10 may receive a request from a user application. Custom model building process 10 may fill a request queue with request information related to the request. The custom model building process 10 may trigger the at least one module (e.g., the at least one processing manager) based on the request information. At least part of the request may be processed based on data assets related to the request. The custom model building process 10 may build a custom model based on, at least in part, the processing of the at least part of the request

In some example implementations, instruction sets and subroutines of the custom model building process 10, which may be stored on storage device, such as storage device 16, coupled to computer 12, may be executed by one or more processors and one or more memory architectures included within computer 12. In some example implementations, storage device 16 may include but may not be limited to: a hard disk drive; a flash drive, a tape drive; an optical drive; a RAID array (or other array); a random access memory (RAM); and a read-only memory (ROM).

In some example implementations, network 14 may be connected to one or more secondary networks (e.g., network 18), examples of which may include but may not be limited to: a local area network; a wide area network; or an intranet, for example.

In some example implementations, computer 12 may include a data store, such as a database (e.g., relational database, object-oriented database, triplestore database, etc.) and may be located within any suitable memory location, such as storage device 16 coupled to computer 12. In some example implementations, data, metadata, information, etc. described throughout the disclosure may be stored in the data store. In some example implementations, computer 12 may utilize any known database management system such as, but not limited to, DB2, in order to provide multi-user access to one or more databases, such as the above noted relational database. In some example implementations, the data store may also be a custom database, such as, for example, a flat file database or an XML database. In some example implementations, any other form(s) of a data storage structure and/or organization may also be used. In some example implementations, the custom model building process 10 may be a component of the data store, a standalone application that interfaces with the above noted data store and/or an applet/application that may be accessed via client applications 22, 24, 26, 28. In some example implementations, the above noted data store may be, in whole or in part, distributed in a cloud computing topology. In this way, computer 12 and storage device 16 may refer to multiple devices, which may also be distributed throughout the network.

In some example implementations, computer 12 may execute a custom model building application (e.g., a custom model building application 20), examples of which may include, but may not be limited to, e.g., a machine learning model building application, a custom model building application, a custom application, or any application that may use the custom model building process 10 (e.g., use a system application programming interface (API)) to create a custom model building application. In some example implementations, the custom model building process 10 and/or the custom model building application 20 may be accessed via one or more of client applications 22, 24, 26, 28. In some example implementations, the custom model building process 10 may be a standalone application, or may be an applet/application/script/extension that may interact with and/or be executed within the custom model building application 20, a component of the custom model building application 20, and/or one or more of client applications 22, 24, 26, 28. In some example implementations, the custom model building application 20 may be a standalone application, or may be an applet/application/script/extension that may interact with and/or be executed within the custom model building process 10, a component of the custom model building process 10, and/or one or more of client applications 22, 24, 26, 28. In some example implementations, one or more of client applications 22, 24, 26, 28 may be a standalone application, or may be an applet/application/script/extension that may interact with and/or be executed within and/or be a component of the custom model building process 10 and/or the custom model building application 20. Examples of client applications 22, 24, 26, 28 may include, but may not be limited to, e.g., a machine learning model building application, a custom model building application, a custom application, or any application that may use the custom model building process 10 (e.g., use a system application programming interface (API)) to create a custom model building application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some example implementations, one or more of storage devices 30, 32, 34, 36, may include but may not be limited to: hard disk drives; flash drives, tape drives; optical drives; RAID arrays; random access memories (RAM); and read-only memories (ROM). Examples of client electronic devices 38, 40, 42, 44 (and/or computer 12) may include, but may not be limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a media (e.g., video, photo, etc.) capturing device, and a dedicated network device. Client electronic devices 38, 40, 42, 44 may each execute an operating system, examples of which may include but may not be limited to, Android™, Apple® iOS®, Mac® OS X®; Red Hat® Linux®, or a custom operating system.

In some example implementations, one or more of client applications 22, 24, 26, 28 may be configured to effectuate some or all of the functionality of custom model building process 10 (and vice versa). Accordingly, in some example implementations, the custom model building process 10 may be a purely server-side application, a purely client-side application, or a hybrid server-side/client-side application that may be cooperatively executed by one or more of client applications 22, 24, 26, 28 and/or the custom model building process 10.

In some example implementations, one or more of client applications 22, 24, 26, 28 may be configured to effectuate some or all of the functionality of the custom model building application 20 (and vice versa). Accordingly, in some example implementations, the custom model building application 20 may be a purely server-side application, a purely client-side application, or a hybrid server-side/client-side application that may be cooperatively executed by one or more of client applications 22, 24, 26, 28 and/or the custom model building application 20. As one or more of client applications 22, 24, 26, 28, the custom model building process 10, and the custom model building application 20, taken singly or in any combination, may effectuate some or all of the same functionality, any description of effectuating such functionality via one or more of client applications 22, 24, 26, 28, the custom model building process 10, the custom model building application 20, or combination thereof, and any described interaction(s) between one or more of client applications 22, 24, 26, 28, the custom model building process 10, the custom model building application 20, or combination thereof to effectuate such functionality, should be taken as an example only and not to limit the scope of the disclosure.

In some example implementations, one or more of users 46, 48, 50, 52 may access computer 12 and the custom model building process 10 (e.g., using one or more of client electronic devices 38, 40, 42, 44) directly through network 14 or through secondary network 18. Further, computer 12 may be connected to network 14 through secondary network 18, as shown with phantom link line 54. The system of the custom model building process 10 may include one or more user interfaces, such as browsers and textual or graphical user interfaces, through which users 46, 48, 50, 52 may access the custom model building process 10.

In some example implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

In some example implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that may allow, e.g., mobile phones, computers, smart phones, and other electronic devices to be interconnected using a short-range wireless connection. Other forms of interconnection (e.g., Near Field Communication (NFC)) may also be used.

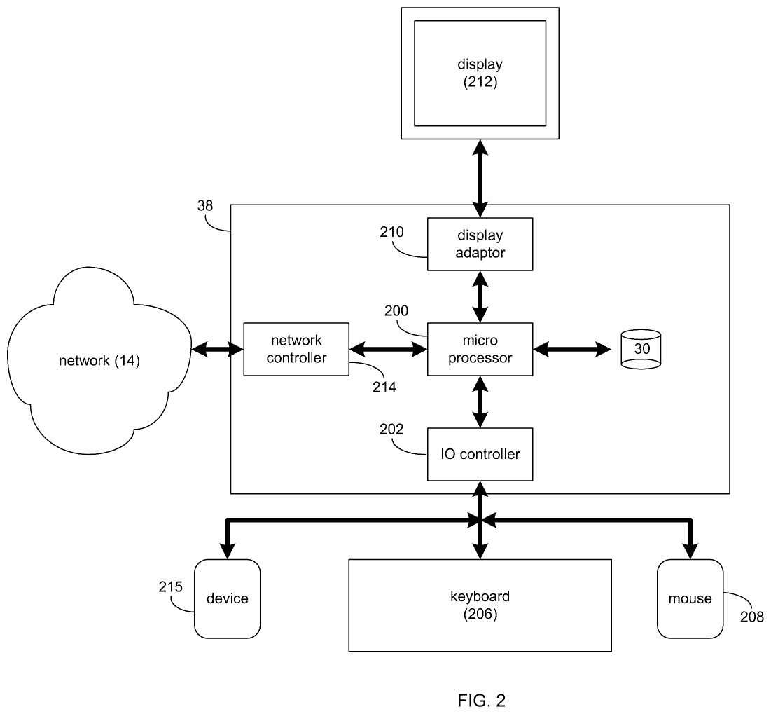

Referring also to the example implementation of FIG. 2, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, custom model building process 10 may be substituted for client electronic device 38 (in whole or in part) within FIG. 2, examples of which may include but are not limited to computer 12 and/or one or more of client electronic devices 38, 40, 42, 44.

In some example implementations, client electronic device 38 may include a processor and/or microprocessor (e.g., microprocessor 200) configured to, e.g., process data and execute the above-noted code/instruction sets and subroutines. Microprocessor 200 may be coupled via a storage adaptor to the above-noted storage device(s) (e.g., storage device 30). An I/O controller (e.g., I/O controller 202) may be configured to couple microprocessor 200 with various devices, such as keyboard 206, pointing/selecting device (e.g., touchpad, touchscreen, mouse 208, etc.), custom device (e.g., device 215), USB ports, and printer ports. A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

As will be discussed below, in some example implementations, the custom model building process 10 may be integrated into a practical application to at least help, for example, improve existing technological processes associated with, e.g., building custom models.

It will be appreciated that the computer processes described throughout are not considered to be well-understood, routine, and conventional functions.

### The Custom Model Building Process:

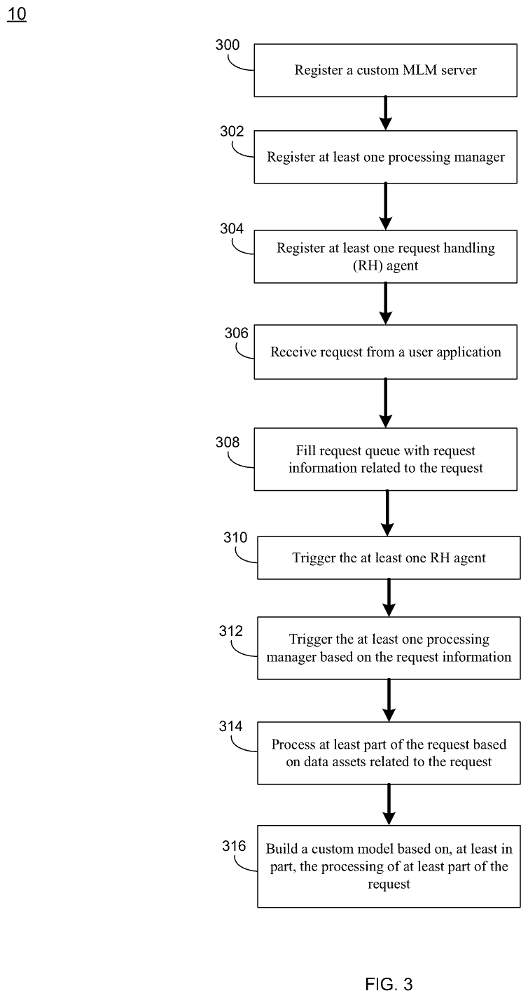

As discussed above and referring also at least to the example implementations of FIGS. 3-10, there is a custom model building process 10. In example implementations, the custom model building process 10 is shown in FIG. 3. The custom model building process 10 is embodied in a flow chart that includes a set of operations for building a custom model. The custom model building process 10 may register a custom machine learning model (MLM) server at 300. The custom model building process 10 may register at least one module (e.g., at least one processing manager) at 302. Also, the custom model building process 10 may register at least one second module (e.g., at least one request handling (RH) agent) at 304. Registration of the custom MLM server, the at least one first module, and the at least one second module may be accomplished by a request queue. The custom model building process 10 may receive a request from a user application (e.g., user application may send the request to the custom MLM server) at 306. The custom model building process 10 may fill a request queue with request information related to the request (e.g., the custom MLM server may fill the request queue with an augmented request) at 308. This request information may include at least one of: a request workflow, one or more required processing managers, and/or a topic. The custom model building process 10 may trigger at least one request handling agent (e.g., trigger based on topic in augmented request of the request queue) at 310. The custom model building process 10 may trigger the at least one processing manager based on the request information (e.g., at least one request handling (RH) agent may provide or direct trigger by changing topic of augmented request) at 312. The custom model building process 10 may process at least part of the request based on data assets related to the request (e.g., this may be done by the at least one processing manager that may be registered as required for the request) at 314. The custom model building process 10 may build a custom model based on, at least in part, the processing of the at least part of the request (e.g., the last processing manager PM in the workflow may build the final requested custom model) at 316.

### The Custom Model Building System:

Referring at least to the example implementation of FIG. 4, there is shown an example custom model building system (e.g., specifically a custom machine learning (ML) building system 100 or simply system 100) that may use the custom model building process 10 for building custom models (e.g., custom ML models), in accordance with one or more example embodiments or implementations of the disclosure. In general, this system diagram shows three different classes of agents, queues, processing request descriptions (e.g., as represented as a graph), different requests, etc. This system diagram shows an overall view of the example components. It will be appreciated that more or less components may be used (and/or arranged differently), with one or more of the functions of the components combined or separated in any combination. As such, the custom ML building system 100 should be taken as example only and not to otherwise limit the scope of the disclosure.

The custom model building process 10 may be used in the system 100 to allow for customization of a language model (e.g., decoding graph). A decoding graph may be defined as an example language model with other resources (e.g., acoustic models, lexicon) in a form that may simplify a decoding process. Typically, organizations may be provided with an initial automatic speech recognition (ASR) decoding graph, but with this example system, the decoding graph may be customized to specific words of an organization's domain (e.g., for an ice cream organization or company user, domain-specific words may include cone, flavor, vanilla, chocolate, bowl, toppings, sprinkles, sauces, fruit, kiddie, etc.). An example input text relating to an ice cream company's domain is shown below in an example. This system 100 may be for user organizations to use on their premise (e.g., where the organization may not want to share any data with a service organization). For other organizations, the customized graph may be generated off-premise with a service organization. This system 100 may include a facility for creating the customized graph on-premise for the organization.

In some example implementations, a user (e.g., user organization) may use the custom model building process 10 to provide requests (Rs), e.g., first request R1, second request R2, and third request R3, etc. where each request may be requesting one type of custom model (e.g., request for a custom language model). Each request R1, R2, R3 may also include data sets related and useful to the process of building the requested custom model (e.g., data set related to customization for a language model may include input text that may have terms or words relevant to the user organization as provided below in the example). The user organization may use a user application 110 to generate these requests (e.g., Rs). In one example, a single user application 110 may be used to generate multiple different requests (e.g., R1, R2, and R2). In another example, a different user application may be used for different requests such that a first user application may generate a first request R1, a second distinct user application may generate a second request R2, and a third distinct user application may generate a third request R3. Use of different applications for different users and requests may be useful where the user organizations may reside in different geographical locations. Other reasons for having multiple distinct user applications may allow for use of the same custom ML building system for multiple different users (e.g., multiple user organizations) from different geographical locations and/or may use possibly different programming languages with different graphical user interfaces (GUIs). Accordingly, the system 100 may use any number of other user application(s) 110X for other users involving any number of requests RX.

The user application 110 or user applications may direct these requests R1, R2, R3 to a front end of the system 100 which may be a custom machine learning model (MLM) server 112. The custom MLM server 112 may be used to receive multiple requests from one or more different organizations. The custom MLM server 112 may be responsible for describing a pipeline sequence. This means that the custom MLM server 112 may respond to a request R1, R2, R3 coming from the user application 110 by building a workflow (WF) of steps that may be needed to implement the request R1, R2, R3. This workflow (WF) of steps may be used in forming one or more workflow graphs 120, 122. The custom MLM server 112 may act like an architect in receiving the request R1, R2, R3 from an organization or customer via the user application 110 and may then design and build a workflow in response to the request R1, R2, R3 and certain purposes.

For each request, the custom MLM server 112 may use the custom model building process 10 to build a proper workflow (e.g., workflow W1, W2, W3) of the request which may be added to the request thereby modifying the request to an augmented request that may be pushed into a request queue 114 (also referred to as queue handler which may manage queues). The request queue 114 may include augmented requests, for instance first augmented request R1′, second augmented request R2′, and third augmented request R3′. The custom MLM server 112 may create workflows W1, W2, W3 for requests R1, R2, R3, respectively. Each workflow may include descriptions of one or more steps required for fulfilling the respective request such as a description of all the processing steps that may be needed for the request (e.g., first workflow W1 may include descriptions of steps and actual acts that may be needed to fulfill first request R1). The first augmented request R1′ may be modified to include the first workflow W1 and its related descriptions of steps. For example, the first augmented request R1′ may include the first workflow W1 for calculating and generating a new model for a machine learning algorithm for an ASR language model. Building the language model for ASR may be part of this first augmented request R1′ which may involve a first workflow D1 that includes descriptions of several steps that may be executed in different parts of the architecture.

Other example requests may include calculating and building new models for different types of systems such as natural language understanding (NLU) ML models, natural language generation (NLG) ML models, dialog management (DM) ML models, text-to-speech (TTS) ML models, etc. The inputs included with these requests may vary. For example, for the NLU ML model request, an example of inputs may include text sentences together with associated labeling such as “main intent of the sentence” e.g. inform/order/query etc. and “entities” such as yearly balance per quarter, etc. For the NLG ML model request, an example of inputs may include “intents+entities” together with examples of natural sentences together with part of speech labels (POS) labeling of natural sentence tokens. For the TTS ML model request, an example of inputs may include specific words such as proper names or street names together with their phonetic transcriptions.

The custom MLM server 112 may use the custom model building process 10 to generate workflows (e.g., WFs W1, W2, W3) for processing each request R1, R2, R3 such that first request workflow W1 corresponds with first request R1, second workflow W2 corresponds with second request R2, third workflow W3 corresponds with third request R3, and so forth. In more detail, a generated workflow may be a description of the steps that may be needed to create a new model (e.g., steps for building a new language model may include a language modeling step, a G2P step, and a decoding model building step). Each workflow may refer to steps that may be required for creating the new model and related data to be used in customizing the model during the building process. The first request workflow W1 for request 1 may be pushed into the request queue 114 within the first augmented request R1′ (similarly second augmented request R2′ and third augmented request R3′ may also be pushed to request queue 114 including second request workflow W2 and third request workflow W3, respectively). Each request workflow W1, W2, W3 may be a complex object that may include a description of all steps that may be needed to accomplish the request (e.g., designed workflow). The request queue 114 may be used as a vehicle (or channel) for routing the designed workflow W1, W2, W3 (within respective augmented requests) to the user organization implementing the workflow.

For each request workflow W1, W2, W3, the custom MLM server 112 may also determine which processing managers (PMs) may be needed or required for accomplishing the original request R1, R2, R3. The custom ML server 114 may add these relevant required PMs to each request workflow W1, W2, W3 (e.g., processing managers PMs 1, 2, 3 may be added for the first request workflow W1, processing managers PMs 1, 2, 3 may be added for second request workflow W2, and processing managers PMs 1, 2, 3, 4, 5, 6 may be added for third request workflow W3). In general, the request queue 114 may act as a facility for transporting information or data (e.g., augmented requests) from the custom MLM server to different processing managers PMs. The request queue 114 may not change the information or data but may simply transport it from one place to another. The custom MLM server 112 may create the workflow (e.g., including descriptions of steps that form the related workflow needed for fulfilling the request) and may include the workflow with the respective augmented request (e.g., first workflow W1 may be with first augmented request R1′). Items in the first augmented request R1′ such as topics T may indicate current state of processing in the workflow.

The system 100 may also include one or more request handling (RH) agent(s) 116. The number of RH agents 116 may be based on the processing requests depending on types of requests expected to be received. Accordingly, in some examples, the system 100 may only include one RH agent 116. In the example shown in FIG. 4, two RH agents 116 (e.g., RH agent 1 and RH agent 2) may be utilized. These RH agents 116 may analyze the augmented requests R1, R2, R3 including the request workflows W1, W2, W3. The RH agents 114 may then distribute information about specific processing managers PMs (e.g., specific PMs already listed in the request queue 114) having associated one or more topics (Ts). Each augmented request R1′, R2′, R3′ (and corresponding request workflows W1, W2, W3) may require at least one processing manager PM (usually more than one processing manager PM) for processing the augmented request R1′, R2′, R3′. Each augmented request R1′, R2′, R3′ may be managed by any number of RH agent(s) 116 (e.g., one or more RH agent(s) 116 may manage augmented requests depending on processing needs for augmented requests).

Augmented requests R1′, R2′, R3′ may be also be managed by one or more specific processing managers PM1, PM2, PM3, PM4, PM5, PM6 at different stages depending on whether the specific processing manager PM1, PM2, PM3, PM4, PM5, PM6 may be relevant or referred to in the augmented request of the request queue 114 (e.g., processing manager may be relevant or referred to when its associated topic T may be marked in request queue). For example, first processing manager PM1 may be associated with first topic T1, second processing manager PM2 may be associated with second topic T2, third processing manager PM3 may be associated with third topic T3, fourth processing manager PM4 may be associated with fourth topic T4, fifth processing manager PM5 may be associated with fifth topic T5, and six processing manager PM6 may be associated with sixth topic T6 such that when these specific topics are marked in request queue 114, the associated processing manager may be triggered. It will be appreciated that more or less processing managers PMs may be used without departing from the scope of the disclosure.

Each augmented request R1′, R2′, R3′ may also have a corresponding request workflow W1, W2, W3, respectively. The RH agents 116 may receive request workflows W1, W2, W3 for each augmented request R1′, R2′, R3′, respectively. According to the request workflow W1, W2, W3, and according to its descriptions, the RH agents 116 may decide to send a message (e.g., in the form of a further augmented request that may be associated with a specific topic T e.g., T1, T2, T3, T4, T5, or T6) to the request queue 114. The request queue 114 may send this augmented request to a first processing manager PM1 if the augmented request includes and is associated with the first topic T1. The request queue 114 may have a column referred to as topics Ts for each augmented request. The topics Ts may change at different stages in the process depending on status of the process 10 and/or the system 100. For example, when the first processing manager PM1 is activated for the first request R1, the respective topics Ts cell of the first augmented request R1′ may be marked with the first topic T1 which may be associated with the first processing manager PM1 thus triggering or activating the first processing manager PM1. The second processing manager PM2 may be activated when the respective topics Ts cell may be marked with second topic T2 which may be associated with the second processing manager PM2. As described in more detail below with respect to FIGS. 5A-5N, the topic T (e.g., topic status) of the of the augmented request (e.g., first augmented request R1′) may change at various stages during the custom model building process 10.

The RH agent may determine that an augmented request (e.g., first augmented request R1′) may be about or involve at least one specific PM (e.g., first processing manager PM1) or a specific group of processing managers PMs (e.g., first augmented request R1′ may involve processing managers PM1, PM2, PM3) based on workflow within the augmented request. In some examples, the RH agent may root messages (e.g., augmented requests) to the request queue 114. The request queue 114 may root the augmented requests to one or more processing managers PMs that all have same functionality but may be replicated in different locations. The custom model building process 10 may break augmented requests by topic T (e.g., process 10 may pull relevant processing managers PMs related to requests even if at different places in dialogue). These relevant processing managers PMs may be standard managers. These processing managers PMs may essentially function with a known mathematical algorithm running them.

In an example implementation, building a new model (e.g., new ASR language model) may include the following three (3) different steps (e.g., using three different processing managers PM1, PM2, and PM3) as part of the first workflow W1 of the first augmented request R1′:
1. Normalize user data→A first processing manager PM1 may respond to messages (e.g., augmented requests) associated to a first topic T1 (e.g., “normalize data” topic T1).
2. Phonetize data→A second processing manager PM2 may respond to messages (e.g., augmented requests) associated to a second topic T2 (e.g., “phonetize data” topic T2).
3. Build decoding graph→A third processing manager PM3 may respond to messages (e.g., augmented requests) associated to a third topic T3 (e.g., “build decoding graph” topic T3).

The system 100 may include resulting workflow graphs such as workflow graphs 120, 122 within workflows (e.g., workflows W1, W2, W3). As shown in FIG. 4, a first workflow graph 120 (e.g., request 1, 2 workflow graph) may correspond to the first and second requests R1, R2 (first and second augmented requests R1′, R2′) and a second workflow graph 122 (also referred to as request 3 workflow graph or third request workflow graph) may correspond to the third request R3 (third augmented request R3′). For example, the workflow graph 120 may include processing steps (and respective processing managers PMs) that may be needed to fulfill the first request R1. The sequence of processing steps may be followed for fulfilling each request (e.g., first request R1). Each workflow graph may be prepared or created by the custom MLM server 112 and each workflow graph may be managed by one or more processing managers PMs. Each relevant processing manager PM may receive augmented requests R1′, R2′, R3′ in which these workflow graphs 120, 122 may be designed to use and implement the relevant processing manager PM for processing at least one step by sending messages to the relevant processing manager PM. Each workflow graph 120, 122 may define a structure of workflow (e.g., type and sequence of processing managers PMs required) and may be associated with requests (e.g., requests R1, R2, R3/augmented requests R1′, R2′, R3′). As shown in FIG. 4, there may be two different requests (e.g., first request R1 and second request R2) that have same/identical first workflow graph 120 and a third request R3 with a different workflow graph (e.g., second workflow graph 122). The first workflow graph 120 may define a structure of workflow (e.g., type and sequence of processing managers PMs required such as PM1, PM2, and PM3 may be required) and may be associated with the first request R1 and second request R2 (e.g., first workflow graph 120 may refer to language model steps that may include the language modeling step, the G2P step, and the decoding model building step where each step may be processed by respective processing manager such as first processing manager PM1, second processing manager PM2, or third processing manager PM3). The second workflow graph 122 may define a structure of workflow (e.g., type and sequence of processing managers PMs required such as first PM1, second PM2, third PM3, fourth PM4, fifth PM5, and six PM6 processing managers may be required) and may be associated with the third request R3.

In general, the system 100 may use the custom model building process 10 for providing various functionality. The custom model building process 10 may trigger a processing manager PM that may be capable of reading augmented requests including request workflows. By monitoring content of workflow graph 120, 122, the custom model building process 10 may determine ordered steps such as starting with processing topic T1 from the request queue 114 triggering the first processing manager PM1. The custom model building process 10 may push one or more items to the augmented request of the request queue 114 (e.g., adding or changing topic T to topics T1-T6). The first topic T1 may be reduced to messages that may be used to trigger and activate the first processing manager PM1 (e.g., where first topic T1 may be marked in the augmented request of the request queue 114). A first block (1) of the workflow graph 120 may refer to the first processing manager PM1 which may be triggered by the first topic T1. As soon as the first processing manager PM1 may finish or complete its use, the first processing manager PM1 may be relieved and made available for further future processing whenever needed. The custom model building process 10 may move to next processing manager (e.g., second processing manager PM2) which may monitor for second topic T2 in the augmented request of the request queue 114 that may trigger the second processing manager PM2. This continues moving from processing manager to processing manager based on the workflow graph 120. Each topic (e.g., topic T1, T2, T3, T4, T5, T6, TX, etc.) may specify an associated processing manager to be used. The custom model building process 10 may use groups of processing managers (e.g., processing managers associated to different topics T) continuously until entire process finishes and fulfills the pending request (e.g., PM1, PM2, and then PM3 may fulfill first request R1).

In a language modeling example, there may be three different topics related to three different processing managers. For example, a first topic T1 may be related to, e.g. calculating a language model (e.g., executed by the first processing manager PM1). A second topic T2 may be related to, e.g., calculating a phonetic representation of a text stream which may include steps for executing a grapheme-to-phoneme (G2P) process (e.g., executed by the second processing manager PM2). A third topic T3 may be related to, e.g. calculating a graph for ASR decoding (e.g., executed by the third processing manager PM3). Further, there may be three blocks of processing managers (e.g., related to topics T1, T2, T3) for building a language model. In this example, the first topic T1 may relate to calculating language model (e.g., when given a number of strings), the second topic T2 may relate to calculating G2P, and the third topic T3 may relate to building a decoding graph. For example, when the first topic T1 is marked in the augmented request (e.g., first augmented request R1′) of the request queue 114, the first processing manager PM1 may be triggered to receive a group of text and the first processing manager PM1 may calculate probability of a word given previous two or three words. When the second topic T2 is marked in the request queue 114, the second processing manager PM2 may be used for G2P which may mean translating each word into phonetic format (e.g., input may be grapheme which may be conventional characters used in text and output may be phoneme which may be alphabetically used to represent sounds that humans may produce). When the third topic T3 may be marked in the request queue 114, the third processing manager PM3 may be used to provide a final step in building a custom language model result (e.g., decoding graph format). This custom language model decoding graph may be used to drive an ASR. Each processing manager PM1, PM2, PM3 may be registered to listen or monitor for respective topics T1, T2, T3 such that whenever a message is queued in the augmented request of the request queue 114 for the topics T1, T2, T3, the processing manager PM1, PM2, PM3 associated with the respective topic may receive the pushed message that may trigger the associated processing manager PM1, PM2, PM3. A resulting custom language model (e.g., decoding graph binary file format) may represent knowledge about language that may include a sequence of words, acoustics, parameters, etc. The ASR may use this custom language model file to run automatic speech recognition. The users (e.g., user organizations) may receive this decoding graph at the end of the process.

The workflow graph (e.g., first workflow graph 120) for this example of building the language model may include three (3) nodes in sequence. The three nodes may relate to first processing manager PM1 for language modeling (e.g., associated with first topic T1), second processing manager PM2 for G2P (e.g., associated with second topic T2), and third processing manager PM3 for building the decoding graph (e.g., associated with third topic T3). These nodes may occur sequentially such that second processing manager PM2 may wait or hold till first processing manager PM1 may be completed and then third processing manager PM3 may wait and hold till first processing manager PM1 and second processing manager PM2 may be completed. The custom model building process 10 may conclude with the creation of a custom language model file (e.g., decoding graph binary file) that may be used with another runtime system (e.g., another runtime ASR system).

The request queue 114 may function or act as a queue or pipeline for transporting data or information (related to one or more requests) such as topics (e.g., topics T1, T2, T3) of the augmented request. These topics T1, T2, T3 may be labels or addresses to which each processing manager PM (e.g., PM1, PM2, PM3, respectively) may be routed for one or more requests. The marking or changing of topics T1, T2, T3 may be capable of triggering e.g. the first block of process (first processing manager PM1), second block of process (second processing manager PM2), and third block of process (third processing manager PM3), respectively, as these topics T each point to specific processing managers. There may be different instances of the first processing managers PM1 that may be capable of implementing the same functionality.

Steps may be run using multiple RH agents 116 via different machines, in different locations, etc. The multiple RH agents 116 may be used to follow up with several requests (e.g., millions of requests) on different machines. Once a step may be completed, such as execution of the first step via the first processing manager PM1 of the workflow graph 12, the RH agents 116 may push a next processing manager by marking next topic in the augmented request of the request queue 114 for the next processing manager (e.g., second topic T2 may be marked to trigger second processing manager PM2).

As shown in FIG. 4, the custom MLM server 112 and processing managers 118 (e.g., PM1, PM2, PM3, PM4, PM5, PM6) may also interact with data assets 124. As described in the disclosure, at least some information from the data assets 124 may be exported to the request queue 114 and the processing managers 118. The processing managers 118 may request and receive relevant information directly from the data assets 124 whereas the request queue 114 may receive relevant information indirectly from the data assets 124 (via the custom MLM server 112).

Referring also at least to the example implementations of FIGS. 5A-5N, there is shown the system of FIG. 4 at each stage of the custom model building process 10, in accordance with one or more example embodiments or implementations of the disclosure. For example purposes only, FIGS. 5A-5N may be used to show a possible use case, for a user (e.g., user organization or company) using the custom model building process 10 to generate a customized model that may be used to improve their automatic speech recognizer (ASR). In this example, the user may be an ice cream company that may use their ASR for recognizing speech on calls for an ice cream business (e.g., may want to accept ice-cream orders using a virtual agent and may have an associated delivery service aimed to bring the requested ice cream product(s) to customer's houses). The virtual agent may use the ASR to correctly understand the customer orders which may be important for keeping costs low, while maintaining a high quality of service by allowing customers to select the appropriate flavors, combinations and offers via the virtual agent. When using the baseline language model for the ASR, the ice cream company may find that the quality of the ASR is fair (e.g., some of the calls may require customers to repeat certain words for the customer to be fully understood by the ASR). This is an indication that the ASR of the virtual agent may need to improve its performance, especially as far as improving understanding of specific words being used during ordering of ice creams. Some of these words may be rather uncommon in normal spoken language. Thus, a custom language model may be needed that may include specific terms that may need to be “taught” or used to train the ASR of the virtual agent system to improve speech recognition performance. The ice cream company may install and start using the custom model building process 10 (e.g., specifically use process 10 with custom ML building system 100) as described in this disclosure for generating the custom language model. The ice cream company may prefer improved ASR performance by replacing or updating its current baseline language model with the custom language model (resulting from the custom model building process 10) for use with the ASR of the virtual agent.

During a startup/registration phase, as shown in FIG. 5A, the request queue 114, the custom MLM server 112, the RH agents 116, and the processing managers 118 may be connected at startup through a registration process that may be driven by configuration variables. Specifically, the custom MLM server 112 may register the custom MLM server 112 as a publisher/subscriber with the request queue 114. The RH agents 116 may register the RH agents 116 (e.g., request handling agent 1 and request handling agent 2) as publishers/subscribers with the request queue 114. The processing managers PMs (e.g., PM1, PM2, PM3, PM4, PM5, and PM6) may be registered as publishers/subscribers with the request queue 114. During this stage of the custom model building process 10, the custom MLM server 112 may interact with the data assets 124. For example, during registration, the custom MLM server 112 may create folders in data assets 124 to serve requests/augmented requests in a rapid manner.

During a next phase, as shown in FIG. 5B, a user application 110 may connect with the custom MLM server 112 and may issue a first request R1 that may include “input text” to the custom MLM server 112. For example, prior to using the user application 110, the ice cream company may collect a text segment which may be representative of a specific domain (e.g., “Ice Cream Ordering” domain) and may be used as input data (e.g., input text). This text may be taken from several sources, either a transcript of actual customer calls, a text about ice-creams in general, a text designed by an expert, or the union of segments from all these sources. The ice cream company may have the responsibility of deciding if the text selected as input data may be relevant for the domain, in terms of the specific words used and about the significance of the sequence of the words that may be monitored in actual customer calls. One example of such “input text” may be given in the following paragraph (the size of this input text may be significantly larger with respect to actual use cases):

ICE CREAM MAY BE SERVED IN DISHES FOR EATING WITH A SPOON OR LICKED FROM EDIBLE CONES ICE CREAM MAY BE SERVED WITH OTHER DESSERTS SUCH AS APPLE PIE OR AS AN INGREDIENT IN ICE CREAM FLOATS SUNDAES MILKSHAKES ICE CREAM CAKES AND EVEN BAKED ITEMS SUCH AS BAKED ALASKA

THE MEANING OF THE NAME ICE CREAM VARIES FROM ONE COUNTRY TO ANOTHER TERMS SUCH AS FROZEN CUSTARD FROZEN YOGURT SORBET GELATO AND OTHERS ARE USED TO DISTINGUISH DIFFERENT VARIETIES AND STYLES IN SOME COUNTRIES SUCH AS THE UNITED STATES ICE CREAM APPLIES ONLY TO A SPECIFIC VARIETY AND MOST GOVERNMENTS REGULATE THE COMMERCIAL USE OF THE VARIOUS TERMS ACCORDING TO THE RELATIVE QUANTITIES OF THE MAIN INGREDIENTS NOTABLY THE AMOUNT OF CREAM TWO PRODUCTS THAT DO NOT MEET THE CRITERIA TO BE CALLED ICE CREAM ARE SOMETIMES LABELLED FROZEN DAIRY DESSERT INSTEAD THREE IN OTHER COUNTRIES SUCH AS ITALY AND ARGENTINA ONE WORD IS USED FOR ALL VARIANTS ANALOGUES MADE FROM DAIRY ALTERNATIVES SUCH AS GOAT'S OR SHEEP'S MILK OR MILK SUBSTITUTES E G SOY CASHEW COCONUT ALMOND MILK OR TOFU ARE AVAILABLE FOR THOSE WHO ARE LACTOSE INTOLERANT ALLERGIC TO DAIRY PROTEIN OR VEGAN

The ice cream company, and for example, specifically an Information

Technology (IT) responsible of this company, may be using the user application 110 (e.g., a web UI or a script of their design) to send the initial first request R1 to the custom MLM server 112. The first request R1 at this stage may be composed of the input text defined above, a requested type of custom model result (e.g., a “custom language model (LM)”), and some other ancillary data such as a date of the request, any needed credentials to use the system, a request ID, which may vary according to the example implementation. For example, the constituent parts of the initial first request R1 may include:
1. Input Text (e.g., See sample “input text” above)
2. Requested Result Type (e.g., a conventional numerical index associated to different types of models such as Custom Language Model may be indexed as “0001”)
3. Ancillary Data (described above and may vary according to the example implementation)

At this stage, the initial first request R1 may not contain any information about which processing steps may be needed to implement the initial request. This design may allow for flexibility. Over time and use of the custom MLM server 112, it may be determined that there may be ideal (e.g., efficient or improved quality) ways of implementing the initial request, using, e.g. a specific sequence of processing managers (e.g. PM1, PM2, PM3) to get to the requested result. For example, after a few months (e.g., three months) of use of the custom MLM server 112, the system 100 may be updated and/or the system 100 may monitor and find an alternative solution to fulfill a previously fulfilled request that may instead use a different sequence of processing managers (e.g. PM1, PM2, PM3, PM4) while still maintaining compatibility in generating the final custom language model result with respect to the ASR engine. In summary, the user application 110 (either a GUI or a script activated by ice cream company) may be completely agnostic in the way the first request R1 may be implemented.

The custom MLM server 112 may complement and/or modify the first request R1 such that the first request R1 may be converted to a first augmented request R1′. For example, the custom MLM server 112 may complement the first request R1 with the added workflow WF (e.g., first workflow W1 including description of steps) which may become part of the first augmented request R1′ (e.g., modified first request R1). The custom MLM server 112 may receive the initial first request R1 and may store some of the data associated with the initial first request R1 in the data assets 124. Specifically, for example, the input data such as the input text (e.g., input text shown above) of the first request R1 may be stored in the data assets 124 (e.g., data assets 124 may receive some input text related to the first request R1 from the user application 110 via the custom MLM server 112). The custom MLM server 112 may then modify the initial first request R1 such that the input text may now be represented with a reference identification (ID) in the first augmented request R1′

In addition, the custom MLM server 112 may modify or augment the initial first request R1 (becoming the first augmented request R1′) to associate new information with the initial first request R1 that was not present before. This new information may include a request workflow WF (e.g., first request workflow W1) which may include an ideal sequence of processing managers (PMs) that may be used to implement the initial first request R1 and a “topic” T. Specifically, in examples, the new information may include first request R1-related information such as request Req. #as R1 or “0001” (refers to Custom Language Model) and request workflow WF #as first request workflow W1 (including a description of steps and required processing managers PMs as PM1, PM2, and PM3). The custom MLM server 112 may add initial topic T (e.g., “RA” topic) that may refer to and may be used to trigger the RH handling agents 116. These topics Ts may also refer to status of augmented requests as these topics Ts may be changed at different stages during the custom model building process 10. Changes to the topic T of each augmented request (e.g., first augmented request R1′) may cause other actions (e.g., topic T may be changed to trigger different components). For example, as described in the disclosure, the topic T may be initially listed as “RA” topic, which may trigger the one or more RH agent(s) 116. The topic may be modified at different stages to trigger other components such as a specific processing manager (e.g., first topic T1 may trigger first processing manager PM1).

The term “request” (e.g., first request R1) may be used in a broader sense, in that the initial first request R1 (e.g., text+intended result+ancillary data) may be modified and augmented (as described in the disclosure) with the new information added by the custom MLM server 112. In this sense, the initial first request R1 may be changed such that the initial first request R1 may now be referred to or modified to the “augmented request” (e.g., first augmented request R1′). As described in the disclosure, this first augmented request R1′ may contain some parts or portions of information that were present in the initial first request R1 plus other information such as the first request workflow W1 (e.g., description of the needed processing steps) and topics T. Information of the first augmented request R1′ may be added and/or changed at different stages of the custom model building process 10. In summary, an example first augmented request R1′ may include:
1. Reference ID referring to Input Text (introduced by custom MLM server 112)
2. Requested Result Type (from original initial request)
3. Ancillary Data (from original initial request)
4. Request Workflow—sequence of processing steps (introduced by custom MLM server 112)
5. Associated Topic (introduced by custom MLM server 112 and marked initially as “RA” which may denote triggering of RH agent(s) 116)

At the end of this stage, the custom MLM server 112 may push this first “augmented” request R1′ to the request queue 114. As described in the disclosure, the first augmented request R1′ may be submitted to the request queue 114 including the “RA” topic which may refer to or be addressed to the RH handling agents 116. The first augmented request R1′ may be implemented by a certain number of processing managers PMs, and the sequencing of the processing managers PMs may be done through one or more RH agent(s) 116. The first request workflow W1 may be understood and represented by the first workflow graph 120 (e.g., first request workflow W1 may be formed or embodied as the first workflow graph 120). Other than related first request R1 data/information being added to the data assets 124 by the custom MLM server 112, the data assets 124 may not be engaged at this stage. Also, the other components such as the RH agents 116 and the processing managers 118 may be idle at this stage.

In the next phase, as shown in FIG. 5C, the request queue 114 may trigger one or more of the available RH agent(s) 116 based on the topic listing “RA”. The RH agent(s) 116 (e.g., RH agent 1 and RH agent 2) may pull the first augmented request R1′ from the request queue 114. This may optionally clean up the request queue 114 which may be now completely void. The RH agent(s) 116 may interpret the request workflow (e.g., first request workflow W1) which may describe the sequence of processing steps for the first request workflow W1. The RH agents 116 (e.g., RH agent 1 and RH agent 2) may receive the first augmented request R1′ including the corresponding first request workflow W1. The RH agent(s) 116 may then change the associated topic T (e.g., topic T for the first augmented request R1′ in the request queue 114) to one of topics that may be assigned to one of the relevant processing managers, e.g. either first processing manager PM1, second processing manager PM2, or third processing manager PM3 thereby triggering this relevant processing manager. For this example, the RH agent(s) 116 may change “RA” topic to first topic T1 which may refer to and trigger the first processing manager PM1 of the processing managers 118. Changing the topic to first topic T1 may assign the first augmented request R1′ to the first processing manager PM1 (e.g., triggering the first processing manager PM1). The other components may be idle. In summary, an example updated augmented request may include:
1. Reference ID referring to Input Text (introduced by custom MLM server 112)
2. Requested Result Type (from original initial request)
3. Ancillary Data (from original initial request)
4. Request Workflow-sequence of processing steps (introduced by custom MLM server 112)
5. Associated Topic (introduced by custom MLM server 112 and RH agent(s) 116 modified topic “RA” to first topic T1)

At the end of this stage, the RH agent(s) 116 may push the above first augmented request R1′ to the request queue 114.

In the next phase, as shown in FIG. 5D, the first processing manager PM1 (or at least one of the instances of the first processing manager PM1 if there are more than one) may take the first augmented request R1′ addressed to first topic T1 (since the first processing manager PM1 has been registered at startup as associated to first topic T1). This may be based on correlation between the first processing manager PM1 and the first topic T1 of the processing managers 118. For example, the request queue 114 may trigger the first processing manager PM1 based on the topic listing first topic T1. The first processing manager PM1 may pull the first augmented request R1′ from the request queue 114 (e.g., may optionally clean up the request queue 114 which may be now completely void). The first processing manager PM1 may read the storage of the data assets 124 and may process at least part of the first request workflow W1 related to the first topic T1. The other components may be idle.

In the next phase, as shown in FIG. 5E, the first processing manager PM1 may complete the processing of at least the part of the first augmented request R1′ associated to the first topic T1 and may write back the results to the storage of the data assets 124 (e.g., via the first augmented request R1′). For example, the first processing manager PM1 may interpret all sections of the current first augmented request R1′. In particular, the first processing manager PM1 may read the original input text by accessing the data assets 124 (via the reference ID), may elaborate the input text of the first augmented request R1′, and may produce new data that may be stored in the data assets 124 that may correspond to the results of this processing. For example, the input text may be analyzed, frequency of each word and sequences of two (“2”) words and sequences of three (“3”) words may be calculated, and tables (e.g., tables reported as in the examples) may be built. “Elaborate” the input text may mean calculating the frequencies for the input text. The resulting tables may be used by the second processing manager PM2 that may convert a format of words calculated by the first processing manager PM1 (and of the sequences of words) to a phonetic representation. Results of the second processing manager PM2 may be later used by the third processing manager PM3.

At the end of this step/function, the first processing manager PM1 may push this new data to data assets 124. For instance, the first processing manager PM1 may calculate frequency of unique words of the input text and frequency of sequence of two or more words. For example, lists of words may be created which may be initially void. The input text may be analyzed word by word (separating them by looking for spaces in between) looking for specific unique words during each analysis. For example, a first word of text may be scanned for in a list of words (e.g., determine whether this first word exists elsewhere in the list). If the answer is “No”, then this word may be added to list with count 1. Then, this process may continue with a second word of text (e.g., determine whether this second word exists in the list). If the answer is “Yes” and the second word exists two times, then this second word or term may be added to the list with count 3 (1+2 times). This may process may be continued with a third word, fourth word, etc. with each time a different unique word being added to the list with a count number. These words may be positioned based on alphabetical ordering. At the end of this process, there may be a list of alphabetically ordered words with count equal to the nuber of times the word may be found in the original input text. This same process may be used for sequences of two and three words (e.g., search for number of times first two words and first three words may be found in input text, then second two words and second three words, and so forth). The first processing manager PM1 may modify the augmented request to add another reference identification (ID) that may refer to the new data (e.g., produced by first processing manager PM1) in the data assets 125

A sample of an example output for the first processing manager PM1 may be shown below for the purpose of explanation only (again the size of these datasets may be larger than explained in this disclosure):

Sample of example “word list” found by first processing manager PM1 from original input text
A
ACCORDING
ALASKA
ALL
ALLERGIC
ALMOND
ALTERNATIVES
AMOUNT
AN
ANALOGUES
AND
ANOTHER
APPLE
APPLIES
ARE
. . .
. . .
TOFU
TWO
UNITED
USE
USED
VARIANTS
VARIES
VARIETIES
VARIETY
VARIOUS
VEGAN
WHO
WITH
WORD
YOGURT

Sample of example “word sequences” estimated by first processing manager PM1 from original input text, in terms of 1-grams (frequency of words), 2-grams (frequency of specific 2 words sequences), 3-grams (frequency of specific 3 words sequences)

| \data\ | |
|---|---|
| ngram 1=121 | |
| ngram 2=180 | |
| ngram 3=192 | |
| \1-grams: | |
| −1.988771 | </s> |
| −99 | <s> −0.009815 |
| −1.988771 | A −0.009815 |
| −2.232113 | ACCORDING −0.009815 |
| −2.232113 | ALASKA −0.009815 |
| ... ... | |
| \2-grams: | |
| −1.772060 | A SPECIFIC −0.018098 |
| −1.772060 | A SPOON −0.018098 |
| −1.270439 | ACCORDING TO −0.018098 |
| ... .. | |
| \3-grams: | |
| −1.169118 | A SPECIFIC VARIETY |
| −1.060152 | A SPOON OR |
| −1.098960 | ACCORDING TO THE |

....

The first processing manager PM1 may update the first augmented request R1′ and may address RH agent(s) 116 as the next agent(s) to further sequence the first augmented request R1′. The updated first augmented request R1′ may now include:
1. Reference ID referring to Input Text (introduced by custom MLM server 112)
2. Requested Result Type (from original initial request)
3. Ancillary Data (from original initial request)
4. Request Workflow (W1)—sequence of processing steps (introduced by custom MLM server 112)
5. Associated Topic (introduced by custom MLM server 112, modified by RH agent(s) 116, and now first processing manager PM1 may modify first topic T1 to “RA” topic)
6. Reference ID referring to Output Data from first processing manager PM1 (e.g., sequence of words and their n-gram frequencies) (introduced by first processing manager PM1)

At the end of this stage, the first processing manager PM1 may push the above further “modified” first augmented request R1′ to the request queue 114. The first processing manager PM1 may mark or modify the topic T of the first augmented request R1′ of the request queue 114 to “RA” topic (e.g., being associated with RH agent(s) 116) for further workflow distribution. The “RA” topic may trigger one of the available RH agent(s) 116. The other components may be idle.

In the next phases, as shown in FIGS. 5F-5K, similar steps may be repeated for the second processing manager PM2 and the third processing manager PM3 including intermediary roles of the RH agents 116 as shown in FIGS. 5C-5E for the first processing manager PM1. In FIG. 5F (similar to FIG. 5C), the topic Ts for the first request R1 of the request queue 114 may be changed from “RA” to T2 (which may refer to the second processing manager PM2). For example, the RH agent(s) 116 may interpret the first request workflow W1 and may change “RA” topic to second topic T2 that may assign the current first augmented request R1′ to the second processing manager PM2. The request queue 114 may then trigger the second processing manager PM2 based on this topic change to second topic T2.

Next, as shown in FIG. 5G (similar to FIG. 5D), the second processing manager PM2 (or at least one of the instances of the second processing manager PM2 if there are more than one) may take the first augmented request R1′ addressed to topic T2 (since the second processing manager PM2 has been registered at startup as associated to second topic T2). This triggering of the second processing manager PM2 may be based on correlation between the second processing manager PM2 and second topic T2. The second processing manager PM2 may pull the first augmented request R1′ from the request queue 114 and may optionally clean up the request queue 114 which may be now completely void. The second processing manager PM2 may read the storage of the data assets 124 and may process at least part of the first request R1 related to the second topic T2.

Next, as shown in FIG. 5H (similar to FIG. 5E), the second processing manager PM2 may complete the processing of at least the part of the first augmented request R1′ associated with the second topic T2 and may write back the results to the storage of the data assets 124 (e.g., via first augmented request R1′). The second processing manager PM2 may interpret all sections of the current first augmented request R1′. For example, the second processing manager PM2 may read the first augmented request R1′ such as read the data produced from the first processing manager PM1 (e.g., PM1 results) that may be obtained via the reference ID referring to output data from the first processing manager PM1. The second processing manager PM2 may produce an output that may be stored in the data assets 124. For instance, the second processing manager PM2 may be a G2P processing manager that may produce results as shown in the disclosure. The second processing manager PM2 may modify the first augmented request R1′ to add another reference identification (ID) that may refer to the new results or output (e.g., produced by the second processing manager PM2) in the data assets 125. One sample of an output for the second processing manager PM2 (e.g., G2P processing) may be shown below in a sample of results for the purpose of explanation only (again the size of these datasets may be larger than explained in this disclosure):

Sample of example output provided by second processing manager PM2—Phonetic alphabet used
AAAA1 AA2
AE AE1
AH AH0 AH1 AH2
AO AO0 AO1 AO2
AW AW1
AY AY0 AY1 AY2
B
CH
D
DH
EH EH0 EH1
ER ER0 ER1
EY EY1 EY2
F
G
HH
IH IH0 IH1 IH2
IY IY0 IY1 IY2
JH
K
L
M
N
NG
Ow Ow0 OW1
. . .

Sample of example output provided by second processing manager PM2—Phonetic representation of lexicon words
!SIL SIL
<SPOKEN_NOISE> SPN
<UNK> SPN
A AH0
A EY1
ACCORDING AH0 K AO1 R D IH0 NG
ALASKA AH0 L AE1 S K AH0
ALL AO1 L
ALLERGIC AH0 L ER1 JH IH0 K
ALMOND AA1 M AH0 N D
ALTERNATIVES AO0 L T ER1 N AH0 T IH0 V Z
AMOUNT AH0 M AW1 NT
AN AE1 N
AN AH0 N
. . .

The second processing manager PM2 may update the first augmented request R1′ and may address RH agent(s) 116 as the next agent(s) to further sequence the first augmented request R1′. For example, the updated first augmented request R1′ may now include:
1. Reference ID referring to Input Text (introduced by custom MLM server 112)
2. Requested Result Type (from original initial request)
3. Ancillary Data (from original initial request)
4. Request Workflow (W1)—sequence of processing steps (introduced by custom MLM server 112)
5. Associated Topic (introduced by custom MLM server 112, modified by RH agent(s) 116, modified by first processing manager PM1, modified by RH agent(s) 116 again, and now second processing manager PM2 may modify second topic T2 to “RA” topic)
6. Reference ID referring to Output Data from first processing manager PM1 (e.g., sequence of words and their n-gram frequencies) (introduced by first processing manager PM1)
7. Reference ID referring to Output Results from second processing manager PM2 (e.g., phonetic alphabet used and the phonetic representation of words in the lexicon) (introduced by second processing manager PM2)

At the end of this stage, the second processing manager PM2 may push the above further “modified” first augmented request R1′ to the request queue 114 that may trigger one of the available RH agent(s) 116. For example, as described in the disclosure, the second processing manager PM2 may modify the associated topic T of the first augmented request R1′ from second topic T2 to “RA” topic (e.g., associated to RH agent(s) 116) for further workflow distribution. The first augmented request R1′ may pushed back to the request queue 114 with the topic changed to “RA”. The “RA” topic of the request queue 114 may trigger one of the available RH agent(s) 116.

Next, in FIG. 5I (similar to FIG. 5F), the topic T for the first augmented request R1′ may be changed from the “RA” topic to a third topic T3 (which may refer to the third processing manager PM3). For example, the RH agent(s) 116 may pull the current augmented request from the request queue 114, may read the first augmented request R1′, may interpret the first request workflow W1, and may change the “RA” topic to the third topic T3 that may assign the first augmented request R1′ to the third processing manager PM3. The RH agent(s) 116 may then push the first augmented request R1′ back to the request queue 114. The request queue 114 may then trigger the third processing manager PM3 based on this change to the third topic T3.

Next, as shown in FIG. 5J (similar to FIG. 5G), the third processing manager PM3 (or at least one of the instances of the third processing manager PM3 if there are more than one) may take the first augmented request R1′ addressed to T3 (since the third processing manager PM3 has been registered at startup). This may be based on correlation between the third processing manager PM3 and third topic T3. For example, the request queue 114 may trigger the third processing manager PM3 which may pull the first augmented request R1′ from the request queue 114 (e.g., may optionally clean up the request queue 114 which may be now completely void). The third processing manager PM3 may read the storage of the data assets 124 and may process at least part of the first request R1 related to the third topic T3.

Next, as shown in FIG. 5K (similar to FIG. 5H), the third processing manager PM3 may complete the processing of at least part of the first augmented request R1′ associated with the third topic T3 (e.g., final step) and may write back the results to the storage of the data assets 124 (e.g., via the first augmented request R1′). The third processing manager PM3 may interpret all sections of the current first augmented request R1′. For example, the third processing manager PM3 may read the current first augmented request R1′ such as read the data produced from the first processing manager PM1 (e.g., PM1 results via the reference ID referring to output data from the first processing manager PM1) and from the second processing manager PM2 (e.g., via reference ID referring to output results from the second processing manager PM2). The third processing manager PM3 may produce an output (e.g., custom language model) that may be stored in the data assets 124. For instance, the third processing manager PM3 may be designed to create or produce the custom language model in a decoding graph form which may be stored in the data assets 124. The custom language model decoding graph may be inherently a binary type of asset that may be formatted according to a defined standard compatible with a particular ASR specification. The third processing manager PM3 may push a further “modified” first augmented request R1′ to the request queue 114 that refers to one of the available RH agent(s) 116. For example, the updated first augmented request R1′ may now include:
1. Reference ID referring to Input Text (introduced by custom MLM server 112)
2. Requested Result Type (from original initial request)
3. Ancillary Data (from original initial request)
4. Request Workflow (W1)—sequence of processing steps (introduced by custom MLM server 112)
5. Associated Topic (introduced by custom MLM server 112, modified by RH agent(s) 116, modified by first processing manager PM1, modified by RH agent(s) 116 again, modified by second processing manager PM2, modified by RH agent(s) 116 again, and now third processing manager PM3 may modify third topic T3 to “RA” topic)
6. Reference ID referring to Output Data from first processing manager PM1 (e.g., sequence of words and their n-gram frequencies) (introduced by first processing manager PM1)
7. Reference ID referring to Output Results from second processing manager PM2 (e.g., phonetic alphabet used and the phonetic representation of words in the lexicon) (introduced by second processing manager PM2)
8. Reference ID referring to Final Result from third processing manager PM3 (e.g., custom language model as a decoding graph) (introduced by third processing manager PM3)

At the end of this stage, the third processing manager PM3 may push the above further “modified” first augmented request R1′ to the request queue 114 that may trigger one of the available RH agent(s) 116. For example, as described in the disclosure, the third processing manager PM3 may modify the first augmented request R1′ specifically modify the associated topic T of the first augmented request R1′ from third topic T3 to “RA” topic (e.g., associated to RH agent(s) 116) for further workflow distribution. This change to “RA” topic may trigger the RH agent(s) 116 to further sequence the first augmented request R1′.

FIGS. 5L-5N show a concluding stage of the custom model building process 10.

In FIG. 5L, the third processing manager PM3 may complete processing and may route to RH agents 116. The custom model building process 10 may include the RH agents 116 marking the first augmented request R1′ as “done” by changing the topic T of the first augmented request R1′ to “MLM”. For example, for this sample use case, the custom language model (e.g., in decoding graph form) may be the requested type of result expected by the ice cream company. The last step of the sequencing task may be implemented by RH agent(s) 116 such that the RH agent(s) 116 may read the current first augmented request R1′. The RH agent(s) 116 may interpret the request workflow (e.g., first request workflow W1) and may note that all referenced processing managers PMs may have completed their processing. The RH agent(s) 116 may then change “RA” topic to “MLM” topic that may assign or address the current first augmented request R1′ to the custom MLM server 112. The custom MLM server 112 may signal the completion of the original initial request. The updated example first augmented request R1′ may now include:
1. Reference ID referring to Input Text (introduced by custom MLM server 112)
2. Requested Result Type (from original initial request)
3. Ancillary Data (from original initial request)
4. Request Workflow (W1)—sequence of processing steps (introduced by custom MLM server 112)
5. Associated Topic (introduced by custom MLM server 112, modified by RH agent(s) 116, modified by first processing manager PM1, modified by RH agent(s) 116 again, modified by second processing manager PM2, modified by RH agent(s) 116 again, modified by third processing manager PM3, and now RH agent(s) 116 may modify “RA” topic to “MLM” topic)
6. Reference ID referring to Output Data from first processing manager PM1 (e.g., sequence of words and their n-gram frequencies) (introduced by first processing manager PM1)
7. Reference ID referring to Output Results from second processing manager PM2 (e.g., phonetic alphabet used and the phonetic representation of words in the lexicon) (introduced by second processing manager PM2)
8. Reference ID referring to Final Result from third processing manager PM3 (e.g., custom language model as a decoding graph) (introduced by third processing manager PM3)

At the end of this stage, the RH agent(s) 116 may push the above further “modified” first augmented request R1′ to the request queue 114 that may trigger the custom MLM server 112. For example, as described in the disclosure, the RH agent(s) 116 may modify the first augmented request R1′ specifically modify the associated topic T of the first augmented request R1′ from “RA” topic to “MLM” topic (e.g., associated to custom MLM server 112) for further workflow distribution. This change to “MLM” topic may trigger the custom MLM server 112.

In FIG. 5M, the custom MLM server 112 may be notified. The user application 110 may call for checking if the custom model building process 10 may have been completed to the custom MLM server 112. As described in the disclosure, when the topic T of the first augmented request R1′ is marked as “MLM” by the RH agent(s) 116, the custom MLM server 12 may receive this information (e.g., the first augmented request R1′) which may indicate that the custom model building process 10 may have completed the build of the originally requested custom model (e.g., custom language model). The custom model may be, for example, at least one of a custom machine learning model, a custom binary asset machine learning model, or a custom machine learning language model (e.g., as relevant to the “ice cream company” example). The custom MLM sever 112 may respond (e.g., provide an “OK” or confirmatory response) to the user application 110 and may provide the user application 110 with the requested custom model directly (e.g., sent directly from the data assets 124). In another example, the custom MLM sever 112 may provide the requested model to the user application 110 via a link (e.g., a handle) to download the requested custom model from the data assets 124. The custom model building process 10 may be finished.

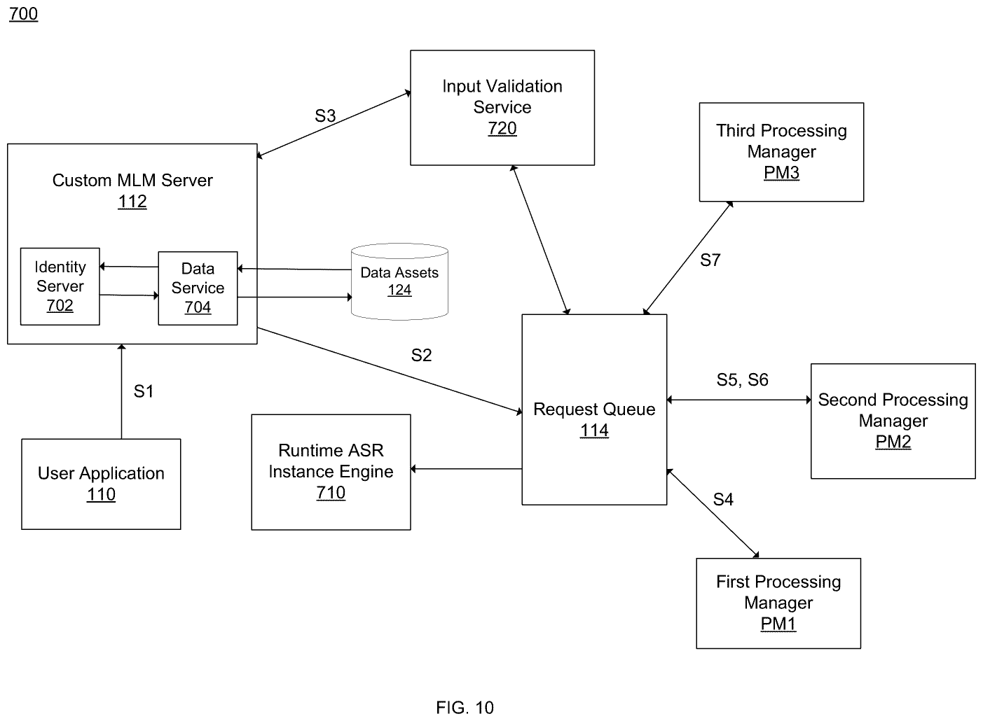

Optionally, as shown in FIG. 5N, the custom model building process 10 may also include triggering a reload of the requested custom model in a runtime system (e.g., runtime ASR instance engine 710) directly such as through some automation as an example. The custom MLM server 112 may read the current first augmented request R1′, may interpret the request workflow (e.g., first request workflow W1), and may trigger (via the request queue 114) one of the available ASR running systems (e.g., ASR instance engine 710 of the virtual agent for the ice cream company). For example, the custom MLM server 112 may trigger the ASR instance engine 710 by requesting the ASR instance engine 710 reload the resulting custom language model (e.g., custom language model in decoding graph form). This custom language model may assist the ASR technology (e.g., runtime ASR instance engine 710) with improvement recognition (e.g., improved interpreting of customer spoken inputs). At the end of this stage, the resulting custom language model may be shipped to at least some if not all running instances of the ASR (e.g., all ASR engines such as the ASR instance engine 710 and other instances of the ASR engine) for the ice cream company. In some examples, the custom MLM server 112 may wipe out or archive all intermediate results from the data assets 124, but this may be optional and may not be relevant for some examples. Whereas previously, the RH agent(s) 116 may modify the “RA” topic to the “MLM” topic, in this example, the RH agent(s) 116 may instead modify the “RA” topic to an “ASR” topic. Specifically, the RH agent(s) 116 may modify the first augmented request R1′ to change the associated topic T of the first augmented request R1′ from the “RA” topic to the “ASR” topic (e.g., associated with the runtime ASR instance engine 710) for further workflow distribution. This change to the “ASR” topic may trigger the runtime ASR instance engine 710 e.g. to load the custom language model in the runtime ASR instance engine 710 (such as from the data assets 124 directly or via a link as described in the disclosure). This is also shown in FIG. 10, for instance, and described in more detail in the disclosure.

A model (e.g., ML model) that may already be in processing may remain in processing until it is finished. The custom MLM server 112 may be changed in order to be capable of producing new models together with old models. One user (e.g., user organization) may request to calculate a new model (e.g., new language model for ASR) which may run for a period of time (e.g., hours, days, weeks) and at a certain point the same custom ML building system 100 may be used to update models (e.g., updated models for a dialogue manager with different data such as different API). This same custom ML building system 100 may be used to create different types of models such as new language models, models for the dialogue manager, and other models etc. Each request (e.g., each augmented request) may populate the request queue 114 with a different structure of pipeline and may root to different processing managers 118 without changing most (if not all) components of the custom ML building system 10. The components of the custom ML building system may generally remain the same even with new updates and/or new requests R.

As such, in some examples as shown in FIGS. 4-5N, the custom ML building system 100 may include a custom MLM server 112, one or more RH agents 116, and one or more processing managers 118 (e.g., PM1, PM2, PM3, PM4, PM5, PM6), associated respectively to processing topics Ts (e.g., T1, T2, T3, T4, T5, T6) of the request queue 114. The request queue 114 topics Ts may be pulled from the processing managers PMs 118 for execution, and processing results may be pushed back to an augmented request of the request queue 114 as processing occurs. Some of the elements of the custom ML building system 100 may be at least partially predefined such as the processing managers 118 (e.g., PMs may be predefined for handling actual predetermined implementation steps) and the RH agents 116. The order of steps for requests may be determined by the custom model building process 10 as described in the disclosure.

Referring also at least to the example implementations of FIGS. 6A-9, there is shown an example of another custom ML building system (e.g., a language custom ML building system 600) that uses the custom model building process 10. The language custom ML building system 600 may be used for building custom machine learning language models. This system 600 may be an example system when applied to language modeling for automatic speech recognition (ASR) applications. The language custom ML building system 600 is an example implementation using the custom model building process 10. Similar to above, this example of the custom model building process 10 may include the following example stages: a language modeling stage, a grapheme-to-phoneme (G2P) stage, and a decoding model building stage. For the language custom ML building system 600, data may be used and may be generated by each component which may be divided into, e.g., three categories of processing managers PM1, PM2, PM (e.g., may have associated three docker images such as resources or static files, input data, and output data). The docker images may be files containing computer readable applications (e.g., processing managers PMs). This example may include three processing managers PM1, PM2, PM3 (e.g., in docker images being built for each stage of this example custom model building process 10). For example, the language modeling stage may include use of the first processing manager PM1 (e.g., language tool for creating, estimating, representing, interpolating, computing, and/or pruning language models such as statistical language models), the G2P stage may include use of the second processing manager PM2 (e.g., G2P converter), and the decoding model building stage may include use of the third processing manager PM3 (e.g., library for constructing, combining, optimizing, and searching weighted finite-state transducers (FSTs)).

In FIGS. 6A-6C, the language custom ML building system 600 may include and show an interaction between the data assets 124 and different processing managers (e.g., first processing manager PM1, second processing manager PM2, or third processing manager PM3) that uses the custom model building process 10 as described in the disclosure. The data assets 124 may include a network file system (NFS) server 602 (or other server) that has a server resources folder, a server text input data folder, and a server output data folder. In some examples, the NFS server 602 may be part of a group of servers. Each processing manager may include a distinct NFS client 604A, 604B, 604C.

For example, FIG. 6A shows the data asset links for the first processing manager PM1 including the NFS client 604A which may include a PM1 client resources folder, a PM1 client text input data folder, and a PM1 client output data folder. The first processing manager PM1 may be the language tool for creating, interpolating, and pruning language models or the statistical language tool for estimating, representing, and computing of statistical language models. In this example, the transfer of information from the server resources folder to the PM1 client resources folder and the server text input data folder to the PM1 client text input data folder may be “read only” and the transfer of information from the server output data folder to the PM1 client output data folder may be “read, write”. Specifically, this example process 10, as shown in FIG. 6A, may include the following example and non-limiting steps: 1: Start the NFS server 602, 2: Start the first processing manager PM1 (e.g., a language model (LM) container or an image launched and operating), 2.1: Automatically mount the folders from the NFS server 602, 3: Start the LM building process based on the test-input-data from NFS server 602, and 4: Write the processed output to the PM1 client output data folder.

FIG. 6B shows the data asset links for the second processing manager PM2 including the NFS client 604B which may include a PM2 client resources folder, a PM2 client text input data folder, and a PM2 client output data folder. The second processing manager PM2 may be the G2P converter. In this example, the transfer of information from the server resources folder to the PM2 client resources folder and the server text input data folder to the PM2 client text input data folder may be “read only” and the transfer of information from the server output data folder to the PM2 client output data folder may be “read, write”. Specifically, this example process 10, as shown in FIG. 6B, may include the following example and non-limiting steps: 1: Start the NFS server 602, 2: Start the second processing manager PM2 (e.g., a G2P container or an image launched and operating), 2.1: Automatically mount the folders from the NFS server 602, 3: Start the G2P building process based on the test-input-data from NFS server 602, and 4: Write the processed output to the PM2 client output data folder.

FIG. 6C shows the data asset links for the third processing manager PM3 including the NFS client 604C which may include a PM3 client resources folder, a PM3 client text input data folder, and a PM3 client output data folder. The third processing manager PM3 may be the library for constructing, combining, optimizing, and searching weighted finite-state transducers (FSTs). In this example, the transfer of information from the server resources folder to the PM3 client resources folder and the server text input data folder to the PM3 client text input data folder may be “read only” and the transfer of information from the server output data folder to the PM3 client output data folder may be “read, write”. Specifically, this example process 10, as shown in FIG. 6C, may include the following example and non-limiting steps: 1: Start the NFS server 602, 2: Start the third processing manager PM3 (e.g., a library container or an image launched and operating), 2.1: Automatically mount the folders from the NFS server 602, 3: Start the decoding model (or graph) building process based on the test-input-data from NFS server 602, and 4: Write the processed output to the PM3 client output data folder.

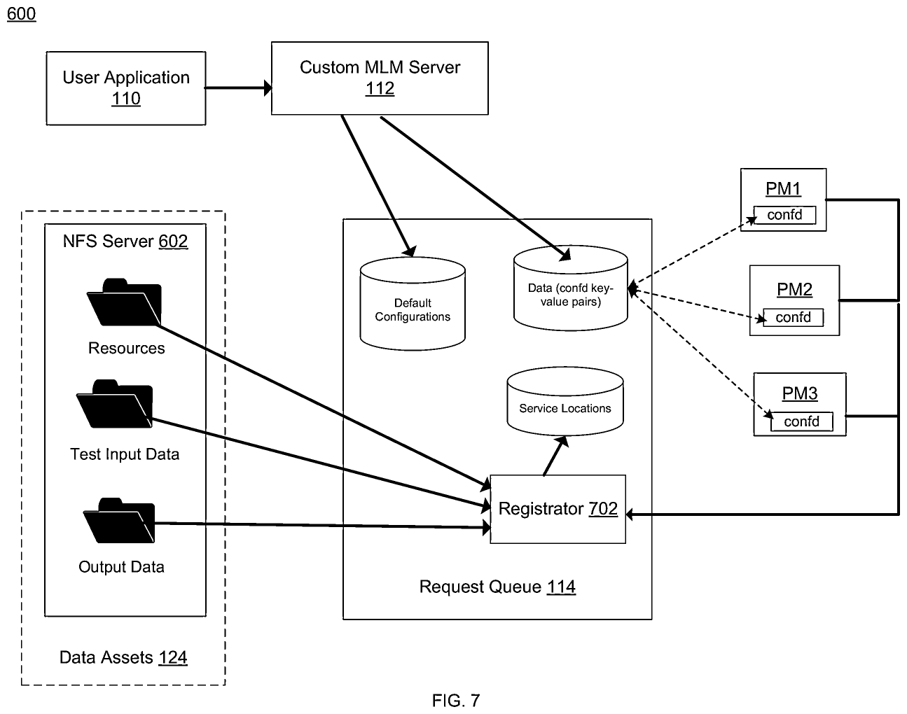

FIG. 7 is a more detailed view of the language custom ML building system 600 of FIGS. 6A-6C. In this example, the request queue 114 may include a registrator 702 used for registration as described in the disclosure. The registrator 702 may automatically register and de-register services for any docker container (e.g., a docker image launched and operating) by inspecting containers as they come online. In this example, the custom MLM server 112 may include a cross-platform runtime environment for server-side and networking applications and/or may include a web application framework for running database-driven websites, applications, and application programming interfaces (APIs). As described in the disclosure, the data assets 124 may include the NFS server 602 including the server resources folder, the server text input data folder, and the server output data folder. As shown in FIG. 7, the request queue 114 may further include default configurations, service locations, and data (e.g., key/value data such as confd key-value pairs). The custom MLM server 112 may provide the default configurations and key/value data to the request queue 114. Each processing manager PM1, PM2, PM3 may include a different confd. Each confd may be a configuration management function or tool that may manage local application configuration files using templates and data from the request queue 114. Each confd may be used with a configuration management system that may actively monitor a store (e.g., a distributed key/value store) and may change config files based on templates whenever keys change. Confd may be used to sync configuration files by polling the request queue 114 and may process template resources. The confd may reload application(s) to access new config file changes. The request queue 114 may use and include a distributed reliable key-value store for most critical data of a distributed system. Specifically, the request queue 114 may provide key-value storage such as store data in hierarchically organized directories as in a standard filesystem. In this example, there are three different types of processing managers PM1, PM2, PM3 as described in the disclosure.

FIG. 7 shows a service discovery stage and confd usage. This service discovery process may include registration of the data assets 124 specifically registration of the folders of the NFS server 602 by the registrator 702 of the request queue 114. The registrator 702 may also register the processing managers PM1, PM2, PM3 as described in the disclosure. During the service discovery stage, the registrator may also send service location information to the service locations store of the request queue 114. FIG. 7 also shows connecting using the confd function or tool where each processing manager PM1, PM2, PM3 may use its confd function or tool to continuously monitor for changes in a specific key and may trigger an event when the key's value changes. These keys may be monitored in a data store (e.g., confd key value pairs) of the request queue 114. The user application 110 may provide various information to a user interface of the custom MLM server 112 that may include configurations (e.g., specific to confd for each processing manager PM1, PM2, PM3), data related to confd key-value pairs, etc.

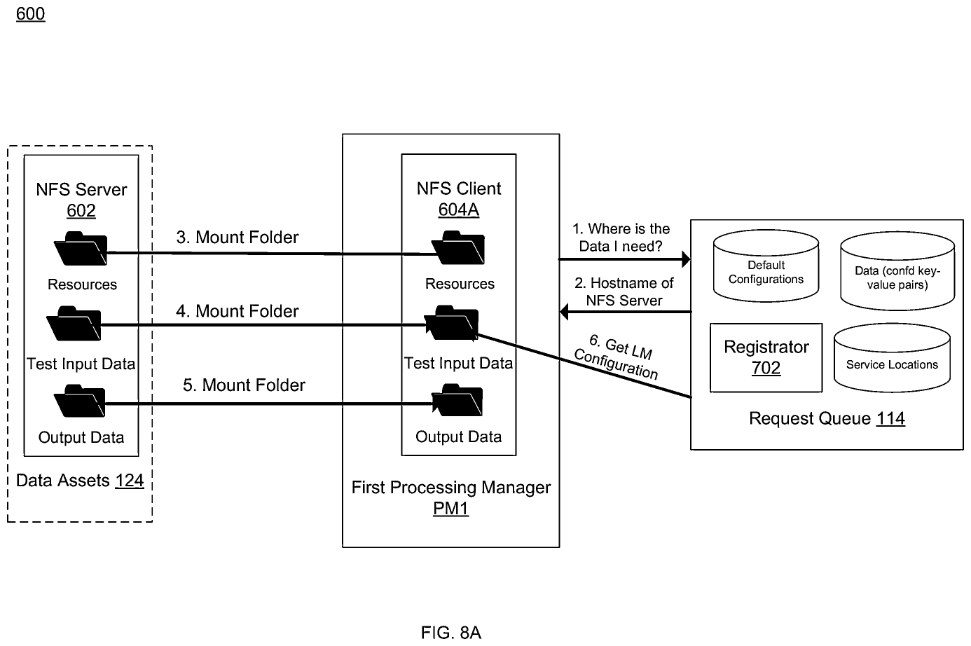

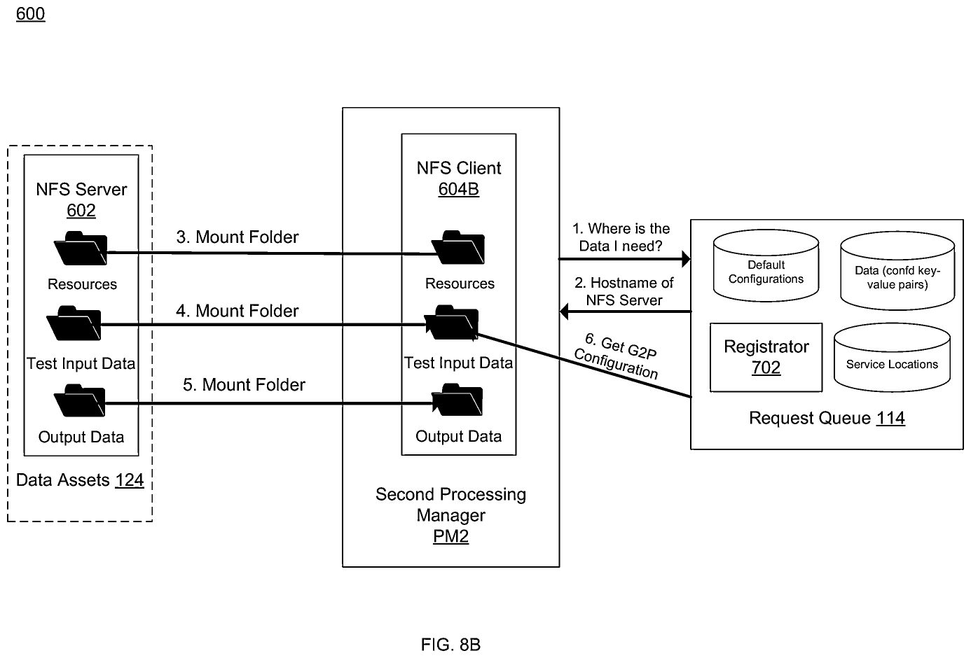

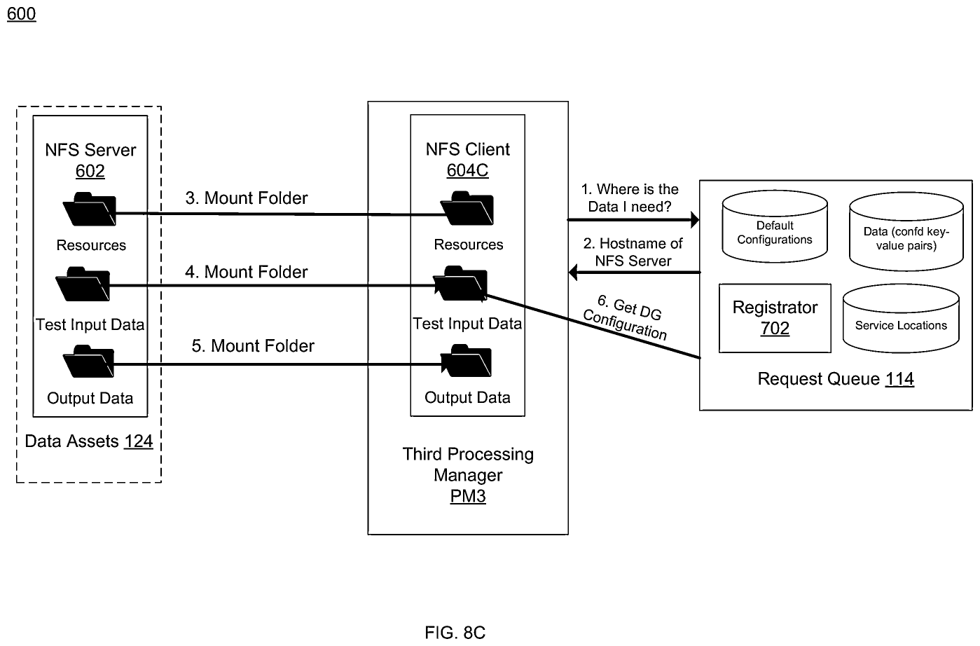

FIGS. 8A-8C show interactions of each processing manager PM1, PM2, PM3, respectively, at three different stages of the custom machine learning model building process 10 for the language custom ML building system 600. As shown in FIG. 8A, the custom machine learning model building process 10 may include a language modeling stage example that may include: 1. First processing manager PM1 may submit request from the request queue 114 for what data may be needed; 2. Request queue 114 may submit hostname of relevant data e.g. hostname of NFS server 602 of the data assets 124 to the first processing manager PM1; 3. NFS server 602 may transfer relevant information from the server resources folder to the PM1 client resources folder of the first NFS client 604A (e.g., by mounting server resources folder); 4. NFS server 602 may transfer relevant information from the server test input data folder to the PM1 client test input data folder of the first NFS client 604A (e.g., by mounting server test input data folder); 5. NFS server 602 may transfer relevant information from the server output data folder to the PM1 client output data folder of the first NFS client 604A (e.g., by mounting server output data folder); 6. Request queue 114 may identify language model (LM) configuration which may be sent to the PM1 client test input data folder of the first NFS client 604A of the first processing manager PM1; and 7. First processing manager PM1 may execute LM process and write output to the PM1 client output data folder of the first NFS client 604A. As shown in FIG. 8B, the custom machine learning model building process 10 may include a G2P stage example that may include: 1. Second processing manager PM2 may submit request from the request queue 114 for what data may be needed; 2. Request queue 114 may submit hostname of relevant data e.g. hostname of NFS server 602 of the data assets 124 to the second processing manager PM2; 3. NFS server 602 may transfer relevant information from the server resources folder to the PM2 client resources folder of the second NFS client 604B (e.g., by mounting server resources folder); 4. NFS server 602 may transfer relevant information from the server test input data folder to the PM2 client test input data folder of the second NFS client 604B (e.g., by mounting server test input data folder); 5. NFS server 602 may transfer relevant information from the server output data folder to the PM2 client output data folder of the second NFS client 604B (e.g., by mounting server output data folder); 6. Request queue 114 may identify G2P configuration which may be sent to the client test input data folder of the second NFS client 604B of the second processing manager PM2; and 7. Second processing manager PM2 may execute G2P process and write output to the PM2 client output data folder of the second NFS client 604B. As shown in FIG. 8C, the custom machine learning model building process 10 may include a decoding graph stage example that may include: 1. Third processing manager PM3 may submit request from the request queue 114 for what data may be needed; 2. Request queue 114 may submit hostname of relevant data e.g. hostname of NFS server 602 of the data assets 124 to the third processing manager PM3; 3. NFS server 602 may transfer relevant information from the server resources folder to the PM3 client resources folder of the third NFS client 604C (e.g., by mounting server resources folder); 4. NFS server 602 may transfer relevant information from the server test input data folder to the PM3 client test input data folder of the third NFS client 604C (e.g., by mounting server test input data folder); 5. NFS server 602 may transfer relevant information from the server output data folder to the PM3 client output data folder of the third NFS client 604C (e.g., by mounting server output data folder); 6. Request queue 114 may identify decoding graph configuration which may be sent to the client test input data folder of the third NFS client 604C of the third processing manager PM3; and 7. Third processing manager PM3 may execute decoding graph process and write output to the PM3 client output data folder of the third NFS client 604C.

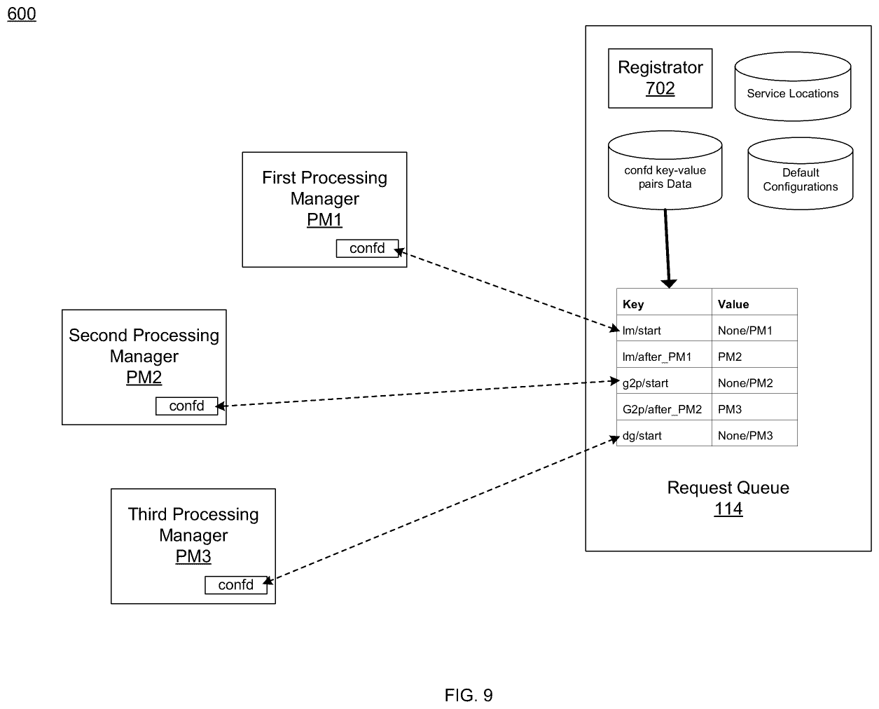

FIG. 9 shows the language custom ML building system 600 implementing an example of at least a portion of the custom machine learning model building process 10 specifically the connection flow process using confd. Different stages (e.g., language modeling stage, G2P stage, and decoding graph stage) of a connection flow may be started and ended by changing values for keys in a key/value table of the request queue 114. This key/value table, as shown in FIG. 9, may be pulled from the confd key-value pairs data of the request queue 114. A connection flow for the first processing manager PM1 using its confd may include: 1. Trigger language modeling stage by starting the first processing manager PM1 (e.g., “lm/start” key may be changed from “none” to “PM1” in table of request queue 114 triggering the first processing manager PM1); and 2. First processing manager PM1 may complete process (e.g., “lm/start” key may be set back to “none” deactivating first processing manager PM1). The second processing manager PM2 may be initiated after the first processing manager PM1 is finished. A connection flow for the second processing manager PM2 using confd may include: 1. Trigger G2P stage by starting second processing manager PM2 (e.g., “g2p/start” key may be changed from “none” to “PM2” in table of request queue 114 triggering the second processing manager PM2); and 2. Second processing manager PM2 may complete process (e.g., “g2p/start” key may be set back to “none” deactivating second processing manager PM2). The third processing manager PM3 may be initiated after the second processing manager PM2 may be finished. A connection flow for the third processing manager PM3 using confd may include: 1. Trigger decoding graph stage by starting third processing manager PM3 (e.g., “dg/start” key may be changed from “none” to “PM3” in table of request queue 114 triggering the third processing manager PM3); and 2. Third processing manager PM3 may complete process (e.g., “dg/start” key may be set back to “none” deactivating third processing manager PM2). Between the language modeling stage and the G2P stage (e.g., between usage of first processing manager PM1 and second processing manager PM2), a “lm/after_PM1” key may be set to PM2. Between the G2P stage and the decoding graph stage (e.g., between usage of second processing manager PM2 and third processing manager PM3), a “G2p/after_PM2” key may be set to PM3. Each processing manager PM1, PM2, PM3 may use its confd to interact with keys of the key/value table (e.g., confd may be used to change values of keys or changed values of keys may be communicated to the relevant processing manager PM1, PM2, PM3 thereby activating/deactivating the relevant processing manager PM1, PM2, PM3).

FIG. 10 shows another language custom ML building system 700 that may be used to implement the custom machine learning model building process 10. This language custom ML building system 700 is similar to the language custom ML building system 600. As described in the disclosure, users may use the user application 110 to submit requests to the custom MLM server 112. The custom MLM server 112 may include an identity server 702 and a data service 704. The identity server 702 may be an identity provider that may create, maintain, and manage identity information for principals while providing authentication services to relying applications within a federation or a distributed network. The identity server 702 may connect with the data service 704 (e.g., connection occurs when data service 704 may send a client grant to the identity server 702 and the identity server 702 may send a token to the data service 704). This connection may be an authentication layer on top of an authorization framework. The data service 704 may be a cloud storage server. The custom MLM server 112 may use the data service 704 to connect and interact with the data assets 124. For example, the data assets 124 may send a token to the data service 704 and the data service 704 may send back temporary credentials that may result in a connection. This connection may be a security token service (STS). The data service 704 may pull objects from the data assets 124. In an example, the custom machine learning model building process 10 may include a stage S1 for posting a job with files and storing them. During this initial stage S1, the user application 110 may post files to the data service 704 of the custom MLM server 112. The data service 704 may engage the identity server 702 and data assets 124, as described in steps in the disclosure, to obtain keys (e.g., access key, secret key, and web token). The custom machine learning model building process 10 may store the files in the data assets 124 using temporary credentials. The request queue 114 may interact with the custom MLM server 112 similarly as described in the disclosure. In an example, the custom MLM server 112 may be a message broker that may foster communication from more than one client or server. The custom machine learning model building process 10 may include a next stage S2 of informing an input-validation service via the request queue 114. During this stage S2, a message may be created (e.g., augmented request created from request) for the request queue 114 (e.g., input-validation service queue) by the custom MLM server 112. The augmented request may include information, as similarly described in the disclosure, such as keys (e.g., web token, user ID, job ID, job configuration, bucket name, process ID (for job status updated), component, etc.).

The language custom ML building system 700 may include three processing managers PM1, PM2, PM3. The first processing manager PM1 may be an NFS client that provides language modeling functionality such that the request queue 114 may input a language modeling service to the first processing manager PM1. The second processing manager PM2 may be an NFS client that provides G2P functionality such that the request queue 114 may input a G2P service to the second processing manager PM2. The third processing manager PM3 may be an NFS client that provides decoding graph functionality such that the request queue 114 may input a decoding graph service to the third processing manager PM3. There may also be an input validation service 720 that may be another NFS client such that the request queue 114 may input validation service-related information to the input validation service 720. For example, the custom machine learning model building process 10 may include another stage S3 where the input validation service 720 may process the augmented request message. During this stage S3, the request queue 114 may receive the augmented request message from the input validation service 720. The custom machine learning model building process 10 may download relevant resulting files stored in data assets 124 to a local NFS storage. The custom machine learning model building process 10 may process the downloaded files and upload the processed files to the data assets 124 via the data service 704 of the custom MLM server 112. In a next stage S4 of the custom machine learning model building process 10, a next component may be informed via the request queue 114. Based on a job configuration in the augmented request, the next component may be determined by the topic listed. The custom machine learning model building process 10 may include an updated augmented request with first topic T1 for the first processing manager PM1. The augmented request message may include seven keys (e.g., web token, user ID, job ID, job configuration, bucket name, process ID (for job status update), component, etc.). In a next stage S5 of the custom machine learning model building process 10, the second processing manager PM2 may process the augmented request message. The second processing manager PM2 may receive the augmented request and may download the relevant files stored in data assets 124 to a local NFS storage. The process 10 may including processing of the downloaded files and may upload the processed files to the data assets 124 via the data service 704 (e.g., data service API) of the custom MLM server 112. In a next stage S6, the custom machine learning model building process 10 may inform next component via the request queue 114. For example, based on the job configuration in the augmented request message of the request queue 114, the next component may be determined. An updated augmented request may be created for the third processing manager PM3. As described in the disclosure, the augmented request may also include seven keys (e.g., web token, user ID, job ID, job configuration, bucket name, process ID (for job status update), component, etc.). In a stage S7, the third processing manager PM3 may result with or output a custom language model decoding graph (as described in the disclosure). The request queue 114 may submit the resulting custom model (e.g., custom ASR service) to a runtime ASR instance engine 710 (e.g., NFS client such as an ASR NFS client that may include a speech recognition toolkit) to be received by a user. The runtime ASR instance engine 710 may receive the resulting custom ML model and may consume the custom ML model.

In some examples, according to requested computational load, there may be an unlimited “number of agent instances”. The following are examples of different numbers of agent instances:
RH agent(s): 0, 1, 2 . . . (also zero (0) instances of RH agent(s) may be allowed, but custom MLM server functionality may be limited to linear pipelines)
First processing manager PM1: 1, 2, . . . (at least one instance may need to exist)
Second processing manager PM2: 1, 2, . . . (at least one instance may exist)
Third processing manager PM3: 1, 2, . . . (at least one instance may exist)

The number of instances of each agent may be independently configured. For example, agents that may require relatively higher computational load may be replicated more frequently compared to other agents that do not require as much computational load. For instance, an example set of configurations may include:
RH agent(s): 1;
First processing manager PM1: 1;
Second processing manager PM2: 1;
Third processing manager PM3: 5→five third processing managers PM3 (versus one third processing manager PM3) may be used here since function or step for third processing manager PM3 may be relatively more computationally intensive with respect to the steps/functions of the first processing PM1 and second processing manager PM2; and
ASR: 2→ice cream company may find that having two ASR running instances may be sufficient for them (other examples may include one ASR, three ASRs, four ASRs, etc.).

Irrespective of the number of instances of ASR, each agent may run in a completely distributed and scalable platform. For example, there may be differently configured instances per region (US vs. Europe vs. Asia). Also, each regional instance may be scaled up or down automatically according to actual use. For example, if several users may be using the RH agent(s) in Asia, corresponding instances of RH agent(s) may be scaled up only in that region.

The custom model building process 10 may be deployed on premise (e.g., custom ML building system 100 may be run entirely within company IT infrastructure) which may reduce the need to access external services (such as Amazon Web Services™, Azure™, etc.). This may allow for unlimited control of data security through suitable firewalls and network designs.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

1.-41. (canceled)

42. A computer-implemented method for building a custom model comprising:
registering at least one module;
receiving a request from a user application;
filling a request queue with request information related to the request; triggering the at least one module based on the request information;
processing at least part of the request based on data assets related to the request; and
building a custom model based on, at least in part, the processing of the at least part of the request.

43. The computer-implemented method of claim 42, wherein the request information includes at least one of: a request workflow, a list of one or more required modules, or a topic.

44. The computer-implemented method of claim 42, further comprising registering at least one second module and triggering the at least one second module based on the request information.

45. The computer-implemented method of claim 44, wherein the at least one module is at least one processing manager and the at least one second module is at least one request handing agent.

46. The computer-implemented method of claim 42, wherein filling the request queue with the request information comprises:
building a request workflow; and
adding the request workflow to the request thereby modifying the request to an augmented request that is pushed into the request queue.

47. The computer-implemented method of claim 46, wherein the at least one module analyzes the augmented request for the request workflow, and wherein the at least one module distributes information about required processing managers in the request queue having associated one or more topics.

48. The computer-implemented method of claim 47, wherein a topic of the one or more topics of the augmented request is added or changed depending on a stage in the request workflow, and wherein the at least one module determines that the augmented request relates to at least one processing manager or a group of processing managers based on the added or changed topic being associated with the at least one processing manager or the group of processing managers.

49. A computer program product residing on a computer readable storage medium having a plurality of instructions stored thereon which, when executed across one or more processors, causes at least a portion of the one or more processors to perform operations comprising:
registering at least one module;
receiving a request from a user application;
filling a request queue with request information related to the request; triggering the at least one module based on the request information;
processing at least part of the request based on data assets related to the request; and
building a custom model based on, at least in part, the processing of the at least part of the request.

50. The computer program product of claim 49, wherein the request information includes at least one of: a request workflow, a list of one or more required modules, or a topic.

51. The computer program product of claim 49, wherein the operations further comprise registering at least one second module and triggering the at least one second module based on the request information.

52. The computer program product of claim 51, wherein the at least one module is at least one processing manager and the at least one second module is at least one request handing agent.

53. The computer program product of claim 49, wherein filling the request queue with the request information comprises:
building a request workflow; and
adding the request workflow to the request thereby modifying the request to an augmented request that is pushed into the request queue.

54. The computer program product of claim 53, wherein the at least one module analyzes the augmented request for the request workflow, and wherein the at least one module distributes information about required processing managers in the request queue having associated one or more topics.

55. The computer program product of claim 54, wherein a topic of the one or more topics of the augmented request is added or changed depending on a stage in the request workflow, and wherein the at least one module determines that the augmented request relates to at least one processing manager or a group of processing managers based on the added or changed topic being associated with the at least one processing manager or the group of processing managers.

56. A computing system including one or more processors and one or more memories configured to perform operations comprising:
registering at least one module;
receiving a request from a user application;
filling a request queue with request information related to the request; triggering the at least one module based on the request information;
processing at least part of the request based on data assets related to the request; and
building a custom model based on, at least in part, the processing of the at least part of the request.

57. The computing system of claim 56, wherein the request information includes at least one of: a request workflow, a list of one or more required modules, or a topic.

58. The computing system of claim 56, wherein the operations further comprise registering at least one second module and triggering the at least one second module based on the request information.

59. The computing system of claim 58, wherein the at least one module is at least one processing manager and the at least one second module is at least one request handing agent.

60. The computing system of claim 56, wherein filling the request queue with the request information comprises:
building a request workflow; and
adding the request workflow to the request thereby modifying the request to an augmented request that is pushed into the request queue.

61. The computing system of claim 60, wherein the at least one module analyzes the augmented request for the request workflow, and wherein the at least one module distributes information about required processing managers in the request queue having associated one or more topics.

62. The computing system of claim 61, wherein a topic of the one or more topics of the augmented request is added or changed depending on a stage in the request workflow, and wherein the at least one module determines that the augmented request relates to at least one processing manager or a group of processing managers based on the added or changed topic being associated with the at least one processing manager or the group of processing managers.
